(19) United States
(12) Patent Application Publication
(10) Pub. No.: US 2026/0051814 A1
(43) Pub. Date: Feb. 19, 2026

(54) STEP-DOWN CHARGE PUMP POWER UP SYSTEMS AND METHODS

(71) Applicant: Murata Manufacturing Co., Ltd., Kyoto (JP)

(72) Inventors: Tim Wen Hui Yu, Fremont, CA (US); Gregory Szczeszynski, Nashua, NH (US)

(21) Appl. No.: 18/809,213

(22) Filed: Aug. 19, 2024

(51) Int. Cl. H02M 3/07; H02M 1/32; H02M 3/158

(52) U.S. Cl. CPC H02M 3/07; H02M 1/32; H02M 3/158

(57) ABSTRACT

The present disclosure relates to charge pumps, and more particularly, to apparatuses, integrated circuits, and methods for powering up a step-down charge pump circuit. In one embodiment, such a method is disclosed for a charge pump circuit comprising a network of interconnected switches couplable to fly capacitors, the network configured to cycle between at least two switching configurations. The switches include a series switch, wherein one of the fly capacitors has a fly capacitor terminal connected to the series switch. The method comprises increasing over a period of time a voltage achieved at the fly capacitor terminal by applying an input voltage at the step-down input node and operating the series switch, determining that the voltage achieved at the fly capacitor terminal exceeds a threshold voltage, and, after which, operating the switches to cycle the network between the at least two switching configurations.

### CROSS-REFERENCE TO RELATED APPLICATION

This application is related by subject matter to co-pending U.S. patent application Ser. No. ______ (Attorney Docket. No. 61658.135US01 ______, titled “STEP-UP CHARGE PUMP POWER UP SYSTEMS AND METHODS,” filed concurrently herewith, which is incorporated by reference herein in its entirety.

### TECHNICAL FIELD

The present disclosure relates to charge pumps, and more particularly, to apparatuses, integrated circuits, and methods for powering up a step-down charge pump power conversion circuit.

### BACKGROUND

Many electronic systems, such as data centers, servers, artificial intelligence (AI) hardware processors, and other high-performance computing systems require power conversion circuits to supply electrical power in suitable form for powering these systems. For example, some electrical systems may require relatively high voltages (e.g., 12 volts (V) or more), and other logic circuitry may require a low voltage level (e.g., 1-2 V). Some other circuits may require an intermediate voltage level (e.g., 5-10 V). Various configurations of switched capacitor power conversion circuits, sometimes also known as “charge pumps,” provide voltage conversion (i.e., step up, step down, or bidirectional) between a high side voltage and a low side voltage through controlled transfers of charge between capacitors in the circuit.

### SUMMARY

Embodiments of the present disclosure provide methods, apparatuses, integrated circuits, and circuit boards for powering up a step-down charge pump power conversion circuit.

In various embodiments, a method for powering up a step-down charge pump power conversion circuit includes configuring a charge pump circuit to operate as a step-down converter. The charge pump may include interconnected switches and fly capacitors, comprising a network operable to cycle between at least two switching configurations. The switches may include a series switch, with the series switch (e.g., a MOSFET) being one of a subset of the switches that are coupled in series between a step-down input node and a step-down output node of the charge pump circuit. One of the fly capacitors may have a fly capacitor terminal connected to the series switch, such as to a source terminal of a MOSFET series switch.

In some embodiments, the method may further include increasing over the period of time a gate-to-source voltage of the MOSFET series switch, and/or controlling a driver circuit coupled to a gate terminal of the MOSFET series switch via a variable current source. In various embodiments, the rates of increase may the same for each series switch or each series switch may have its own corresponding rate of increase.

In some embodiments, the method may further include increasing over a period of time a voltage achieved at the fly capacitor terminal by applying an input voltage at the step-down input node and operating the series switch. In some embodiments, the series switch is a current source the method further includes increasing over the period of time a current sourced by the series switch. The method may further include determining that the voltage achieved at the fly capacitor terminal exceeds a threshold voltage.

In some embodiments, after determining that the voltage achieved at the fly capacitor terminal exceeds the threshold voltage, the method includes operating the switches to cycle the network between the at least two switching configurations.

In various embodiments, an apparatus includes a charge pump circuit, including a network of interconnected switches couplable to fly capacitors, the network configured to cycle between at least two switching configurations. The switches may include a series switch, which is one of a subset of the switches that are coupled in series between a step-down input node and a step-down output node of the charge pump circuit. One of the fly capacitors may have a fly capacitor terminal connected to the series switch.

In some embodiments, the charge pump circuit is further configured to increase over a period of time a voltage achieved at the fly capacitor terminal by applying an input voltage at the step-down input node and operating the series switch, determining that the voltage achieved at the fly capacitor terminal exceeds a threshold voltage, and operating the switches to cycle the network between the at least two switching configurations.

In some embodiments, the charge pump circuit is configured to increase over the period of time a gate-to-source voltage of the MOSFET series switch. The charge pump circuit may further include a driver circuit coupled to a gate terminal of the MOSFET series switch, wherein a voltage output of the driver circuit is configured to be the controlled via a variable current source. In some embodiments, the series switch may be a current source, and the charge pump circuit may be configured to increase over the period of time a current sourced by the series switch.

In some embodiments, each fly capacitor may have a corresponding fly capacitor terminal connected to at least two of the subset of the switches that are coupled in series between the step-down input node and the step-down output node of the charge pump circuit, and the charge pump circuit may be further configured to increase over the period of time voltages achieved at the fly capacitor terminals, determine that the voltages achieved at the fly capacitor terminals exceed corresponding threshold voltages, and after determining that the voltages achieved at the fly capacitor terminals exceed the corresponding threshold voltages, operate the switches to transition the network between the at least two switching configurations.

In various embodiments, an integrated circuit includes a charge pump circuit and further includes a charge pump controller circuit, the charge pump controller circuit couplable to a plurality of switches and a plurality of fly capacitors forming a network of interconnected switches and fly capacitors, wherein each switch is operable between ON and OFF states to cycle the network between at least two switching configurations. The charge pump controller circuit may be further operable to control the configuration and operation of the charge pump circuit in the step-down mode and/or a step-up mode.

It is to be understood that the foregoing general description and the following detailed description of example embodiments are explanatory only, and are not restrictive of the invention, as claimed.

### BRIEF DESCRIPTION OF THE DRAWINGS

FIGS. 1A-1D are circuit diagrams of example switched capacitor networks configured for use as a charge pump power conversion circuit.

FIGS. 2A-2B are effective circuit diagrams of switched capacitor networks in different switching configurations, consistent with disclosed embodiments.

FIGS. 3A-3B are effective circuit diagrams of switched capacitor networks in different switching configurations with partially enhanced MOSFET switches, consistent with disclosed embodiments.

FIG. 4 is a circuit diagram of an example circuit configuration using current sources to pre-charge the fly capacitors prior to commencing switching operations, consistent with disclosed embodiments.

FIG. 5A is a circuit diagram of an example switched capacitor network configured for use as a charge pump power conversion circuit in a step-up conversion mode.

FIGS. 5B-5C are effective circuit diagrams of switched capacitor networks in different switching configurations in a step-up conversion mode, consistent with disclosed embodiments.

FIG. 5D is flow diagram illustrating an example process for powering up the example switched capacitor network of FIGS. 5A-C for operation in a step-up conversion mode.

FIG. 6A provides an example graph illustrating the voltages generated by the switched capacitor network 100 of FIG. 1A.

FIG. 6B provides an example graph illustrating ramping of enhancement factors for switches provided in a switched capacitor network, consistent with disclosed embodiments.

FIG. 6C provides an example graph illustrating the voltages generated by the switched capacitor network 500.

FIG. 7 and FIG. 8 are examples graphs showing the results of a computer simulation of the start-up a 3× voltage transformation ratio switched capacitor network operating as a step-up power converter.

FIG. 9A is a circuit diagram of an example switched capacitor network configured for use as a charge pump power conversion circuit in a step-down conversion mode.

FIG. 9B provides example graphs illustrating ramping of enhancement factors for switches provided in a switched capacitor network, consistent with disclosed embodiments.

FIG. 9C is flow diagram illustrating an example process for powering up the example switched capacitor network of FIGS. 9A-B for operation in a step-down conversion mode.

FIGS. 10-11 are circuit diagrams illustrating further example aspects of a charge pump power conversion circuit, consistent with disclosed embodiments.

FIG. 12 illustrates example control circuitry, switching circuitry, and fly capacitors for a step-up/step-down charge pump, consistent with disclosed embodiments.

### DETAILED DESCRIPTION

The following disclosure provides many different embodiments, or examples, for implementing different features of the provided subject matter. Specific simplified examples of components and arrangements are described below to explain the present disclosure. These are, of course, merely examples and are not intended to be limiting. Further, certain features may be omitted from some figures and description for clarity, and it is to be understood that different features from different drawings and/or portions of the specification may be combined in a single embodiment, and the present disclosure contemplates all such embodiments that combine different features from the different drawings and/or portions of the specification. In addition, the present disclosure may repeat reference numerals and/or letters in the various examples. This repetition is for the purpose of simplicity and clarity and, unless stated otherwise, does not necessarily dictate a relationship between the various embodiments and/or configurations discussed.

The present disclosure provides improved soft-start systems and methods that facilitate safe and efficient startup of charge pump power conversion circuits, which may be configurable to operate in a step-up mode (e.g., boost mode) and/or a step-down mode (e.g., buck mode). In some embodiments, the improved soft-start methods disclosed herein, and related control circuitry, may be implemented for operation with a variety of charge pump power conversion circuit designs, including charge pumps power conversion circuits having fly capacitors and/or switches with characteristics that are unknown to the control circuitry. For example, the control circuitry, switching circuitry, and/or fly capacitors may be provided in two or more integrated circuits, separately designed and selected based on desired system requirements (e.g., a first integrated circuit including a plurality of fly capacitors and a second integrated circuit including a network of power switches).

In some embodiments disclosed herein, the charge pump power conversion circuit may be configured to operate in a step-up mode. The control circuity may be configured to implement a multi-phase, bootstrapping soft-start process having a first phase in which the power switches (e.g., MOSFET power switches) are fully enhanced providing a path from an input voltage source (e.g., V_{LO}) to the positive terminal of a first fly capacitor and a path from the negative terminal of the first fly capacitor to a reference voltage (e.g., electrical ground). In a second phase, the positive terminal of the first fly capacitor is connected to the positive terminal of a second fly capacitor, and the negative terminal of the first fly capacitor is connected to the input voltage source via a phased power switch that is partially enhanced via a ramp gate voltage during the soft-start process. By phasing the ramp gate voltage, the phased power switch is initially operated at a higher resistivity, thereby limiting the current and the output voltage of the charge pump.

The ramp gate voltage may be gradually increased across a plurality of switching cycles until a desired voltage level of the charge pump power conversion circuit is reached. The control circuitry may then exit the soft-start process and control the switches of the charge pump power conversion circuit in the step-up mode of operation.

In some embodiments disclosed herein, the charge pump power conversion circuit may be configured to operate as a step-down charge pump power conversion circuit (e.g., in a buck mode). The charge pump power conversion circuit may include a plurality of fly capacitors, each fly capacitor having a positive terminal electrically connected between a corresponding pair of series switches, and a negative terminal electrically connected between a pair of phase switches, as described further herein. The control circuitry may be configured to implement a soft-start process in which each of the plurality of series switches is partially enhanced via a ramp gate voltage during the soft-start process. By phasing the ramp gate voltage, the series switches are initially operated at a higher resistivity (e.g., than when operated fully enhanced) to limit the source voltage during startup. In some embodiments, the ramp gate voltage is gradually increased across a period of time until a desired voltage level is reached and/or the series switches are full enhanced. The control circuitry may then exit the soft-start process and control the switches of the charge pump circuit in the step-down mode of operation.

Various embodiments of charge pump power conversion circuits and soft-start procedures for pre-biasing the fly capacitors will now be described in further detail, including an improved soft-start process for a step-up charge pump power conversion circuit and an improved soft-start process for a step-down charge pump power conversion circuit.

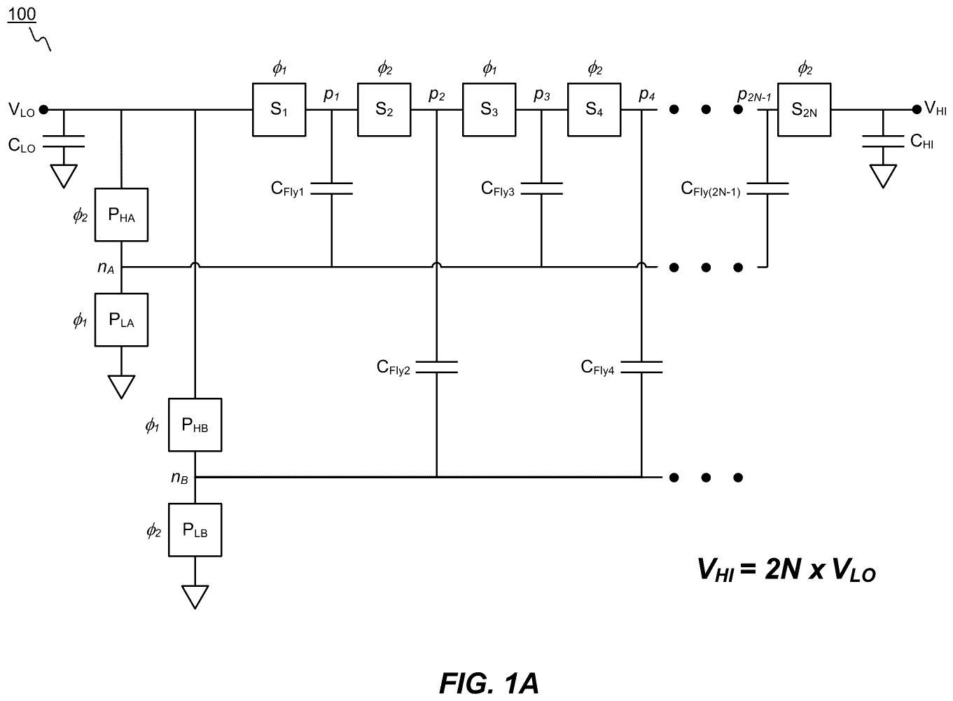

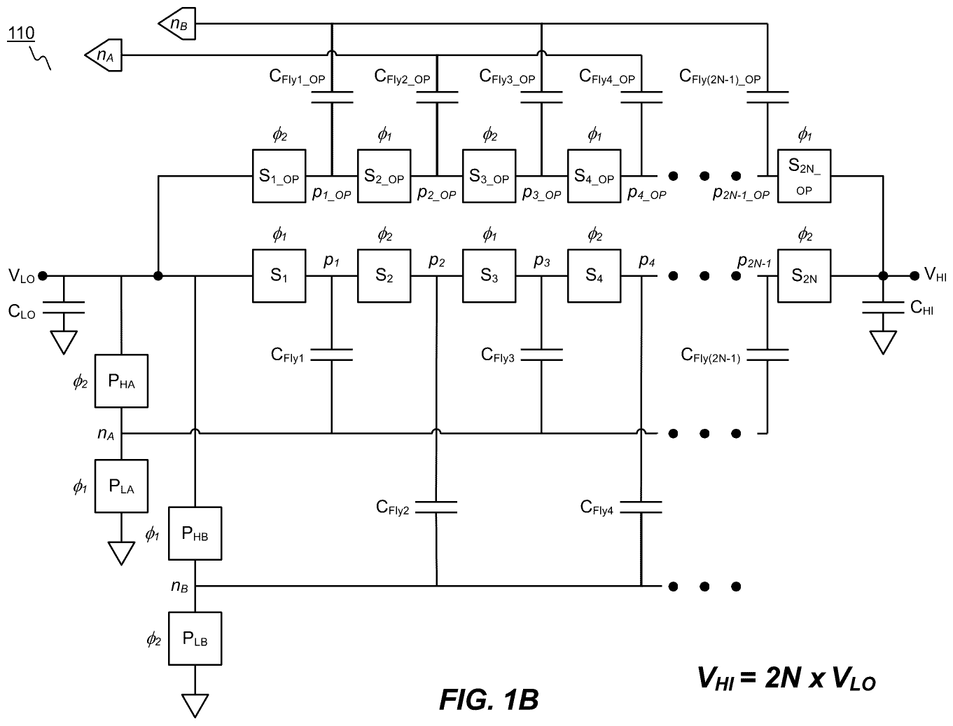

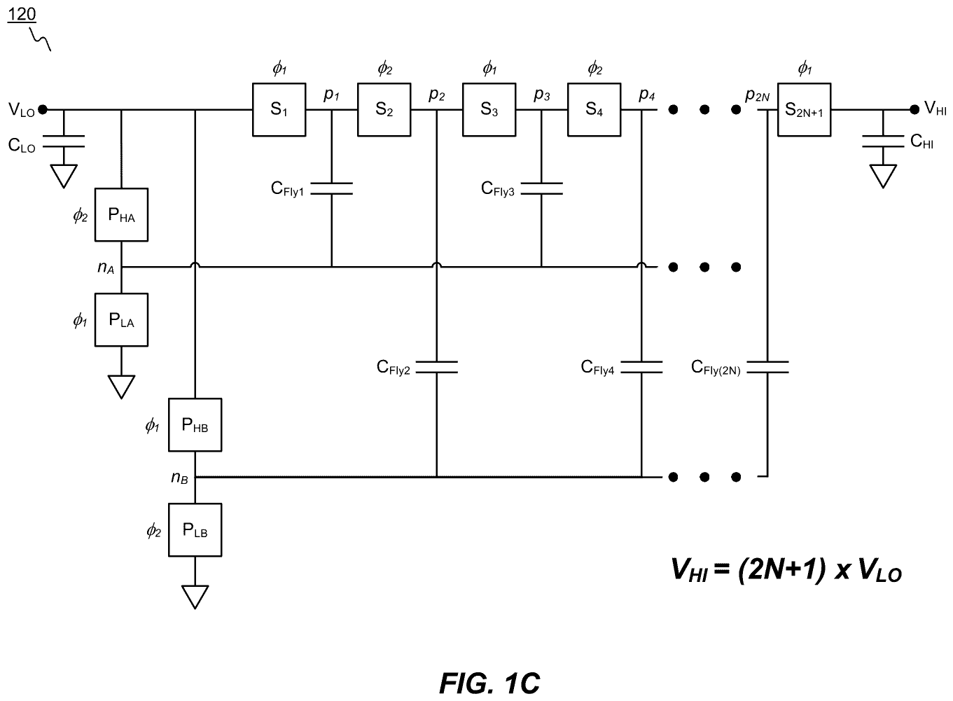

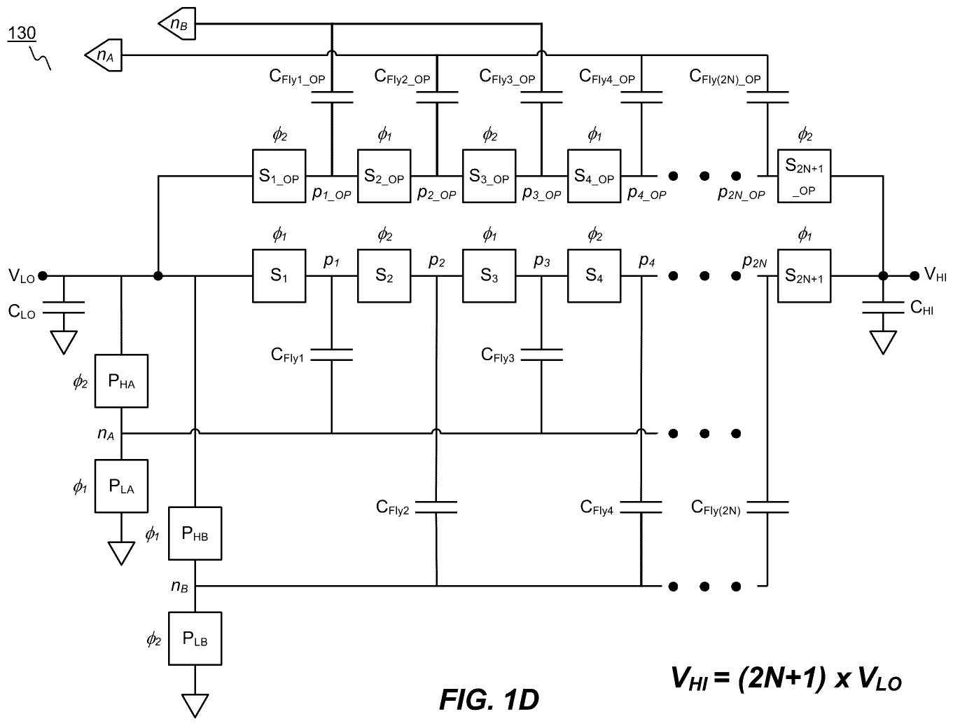

FIG. 1A is a (partial) circuit diagram of an example switched capacitor network 100 configured as a charge pump power conversion circuit. In this example embodiment, switched capacitor network 100 operates in steady-state as a DC-DC converter that is configured to transform power between a low-side voltage V_{LO} and a high-side voltage V_{HI}, where in steady state V_{LO} and V_{HI} satisfy the mathematical relationship V_{HI}=2N×V_{LO}, N being a positive integer (i.e., 1, 2, 3, etc.). In this regard, switched capacitor network 100 is capable of operating as a step-up converter in a step-up conversion mode or a step-down converter (e.g., a step-down DC-DC converter) in a step-down conversion mode. In a step-up conversion mode, switched capacitor network 100 transforms a low-side input voltage V_{LO} into a high-side output voltage V_{HI} in steady state operation. In a step-down conversion mode, switched capacitor network 100 transforms a high-side input voltage V_{HI} into a low-side output voltage V_{LO} in steady state operation.

As shown in FIG. 1A, switched capacitor network 100 includes a plurality of fly capacitors C_{Fly1}, C_{Fly2}, . . . C_{Fly(2N-1)}. The fly capacitors are coupled to a network of interconnected switches that are operable between ON and OFF states to control charge transfer between the fly capacitors. In various embodiments, these switches are N-channel enhancement type metal-oxide-semiconductor field-effect transistors (MOSFETs), but it is to be understood that any other type of MOSFET, and indeed any other type of known switching device, may be used. Switched capacitor network 100 includes four “phase” switches P_{LA}, P_{LB}, P_{HA}, and P_{HB}, and a plurality of “series” switches S₁, S₂, . . . S_{2N}, the number of series switches (or, correspondingly, the number of fly capacitors) determining the voltage transformation ratio (in this example, 2N) between the low-side voltage V_{LO} and the high-side voltage V_{HI}. In some embodiments, switched capacitor network 100 may be reconfigurable in that the number of series switches S₁, S₂, . . . Sₖ (or, correspondingly, the number of fly capacitors C_{Fly1}, C_{Fly2}, . . . C_{Fly(k-1)}) actually operated can be varied to provide a variable voltage transformation ratio between the low-side voltage V_{LO} and the high-side voltage V_{HI}.

Each of the fly capacitors C_{Fly1}, C_{Fly2}, . . . C_{Fly(2N-1)} is electrically connected between a pair of series switches and a pair of phase switches. For example, fly capacitors C_{Fly1}, C_{Fly3}, . . . C_{Fly(2N-1)} each have their “positive” terminals p₁, p₃, . . . p_{2N-1} electrically connected between a pair of series switches (S₁, S₂), (S₃, S₄), . . . (S_{2N-1}, S_{2N}) respectively, and their “negative” terminals n_{A} all electrically connected between a first pair (P_{LA}, P_{HA}) of the phase switches. Similarly, fly capacitors C_{Fly2}, C_{Fly4}, . . . C_{Fly(2N-2)} each have their “positive” terminals p₂, p₄, . . . p_{2N-2} electrically connected between a pair of series switches (S₂, S₃), (S₄, S₅), . . . (S_{2N-2}, S_{2N-1}) respectively, and their “negative” terminals n_{B} all electrically connected between a second pair (P_{LB}, P_{HB}) of the phase switches.

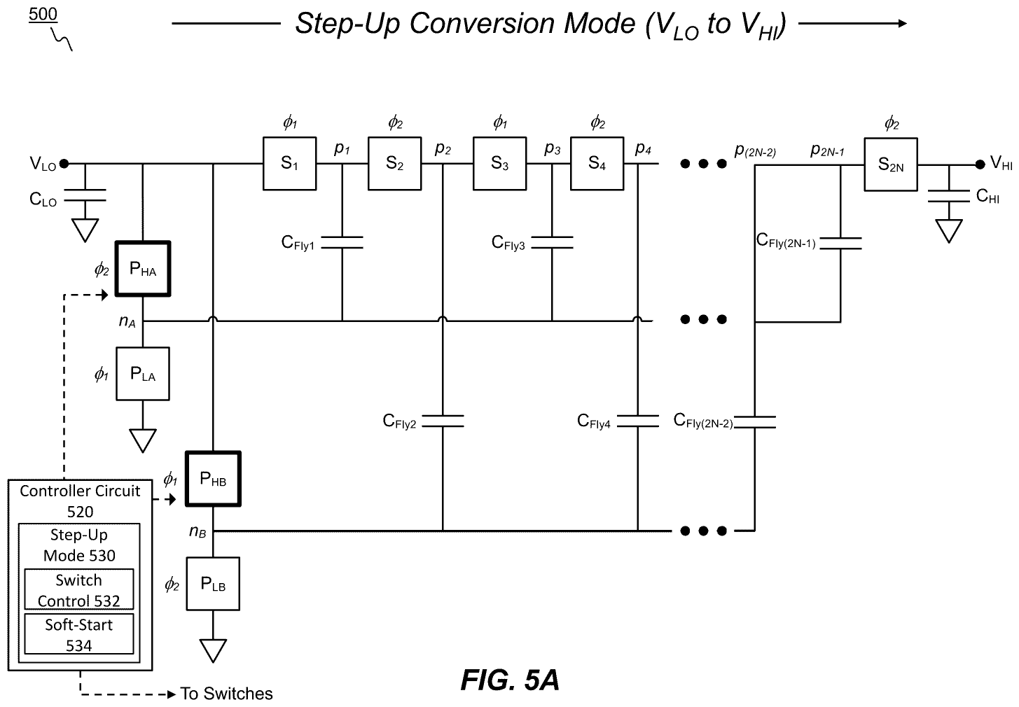

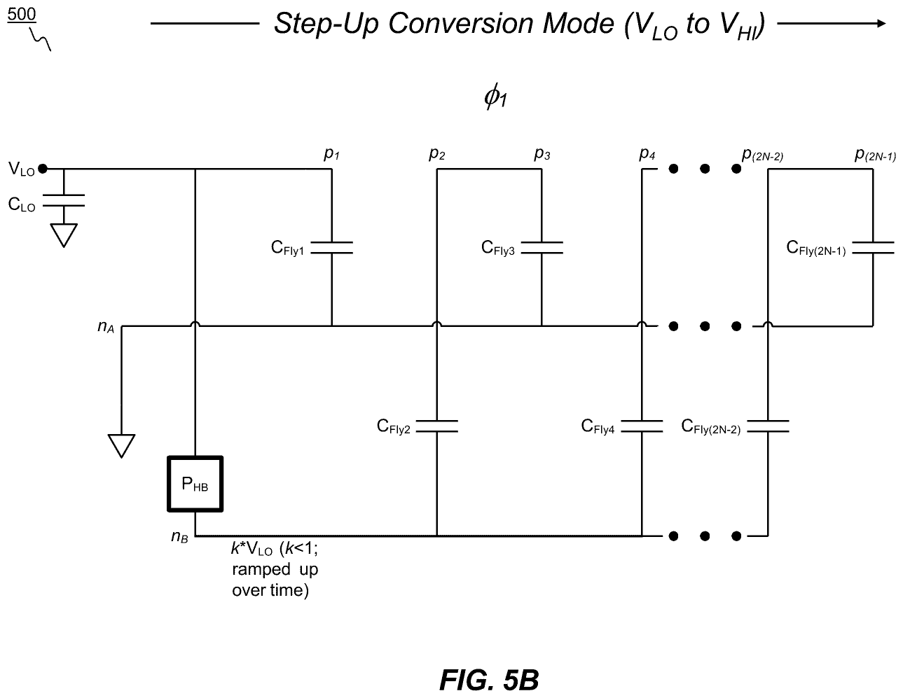

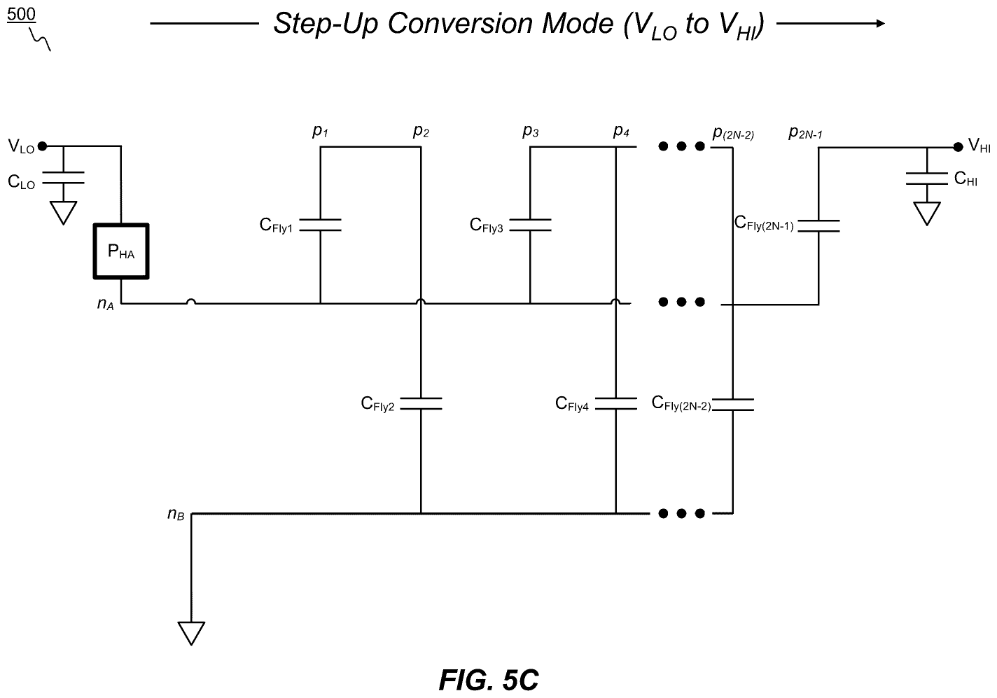

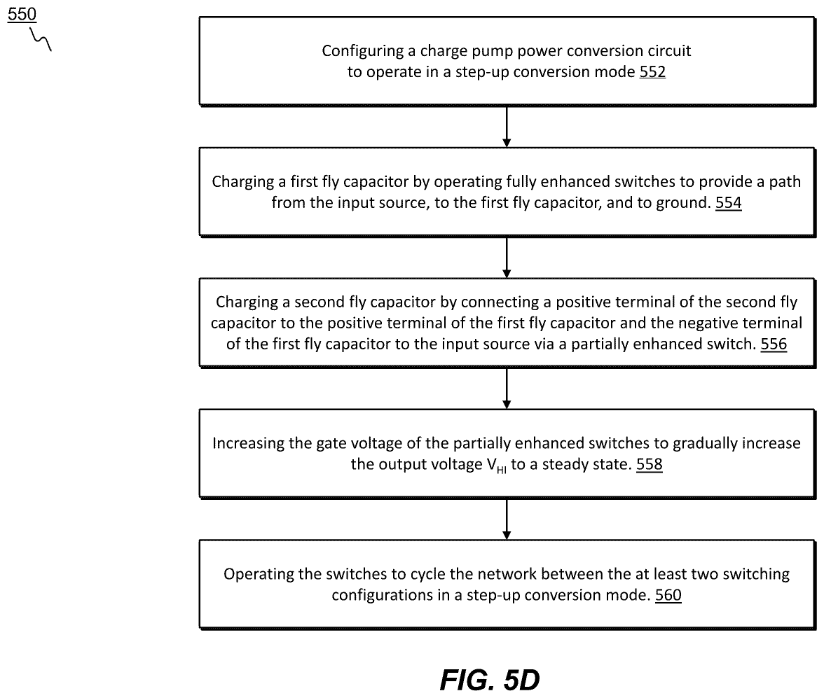

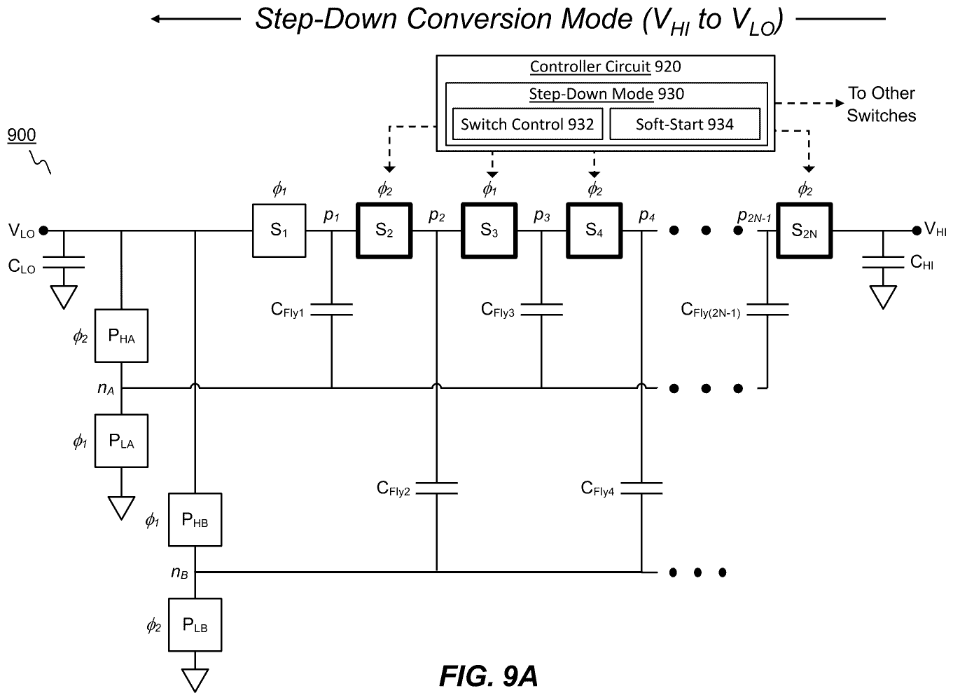

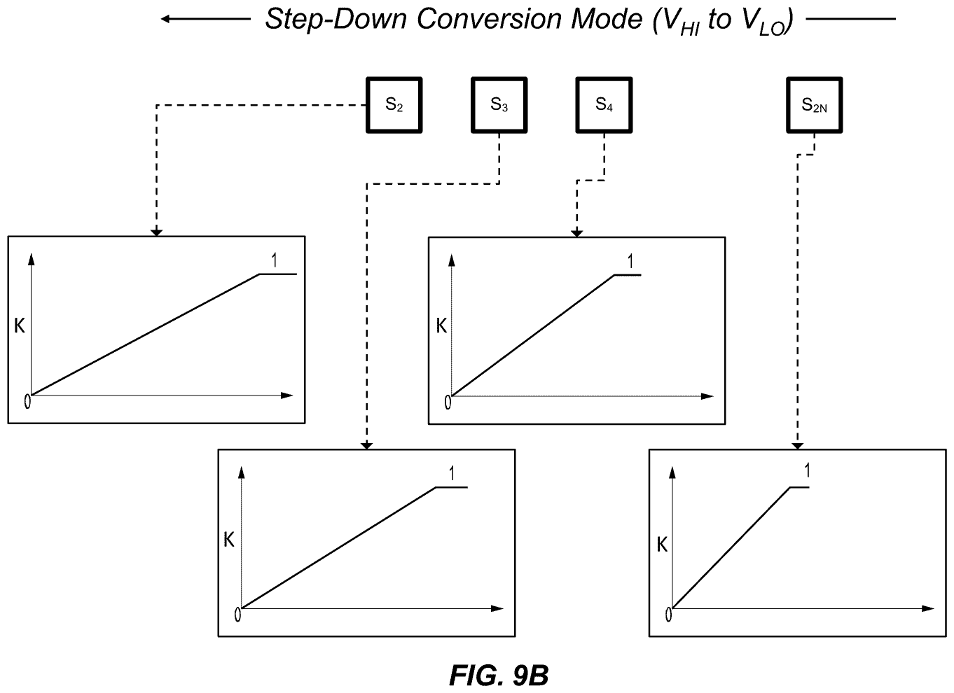

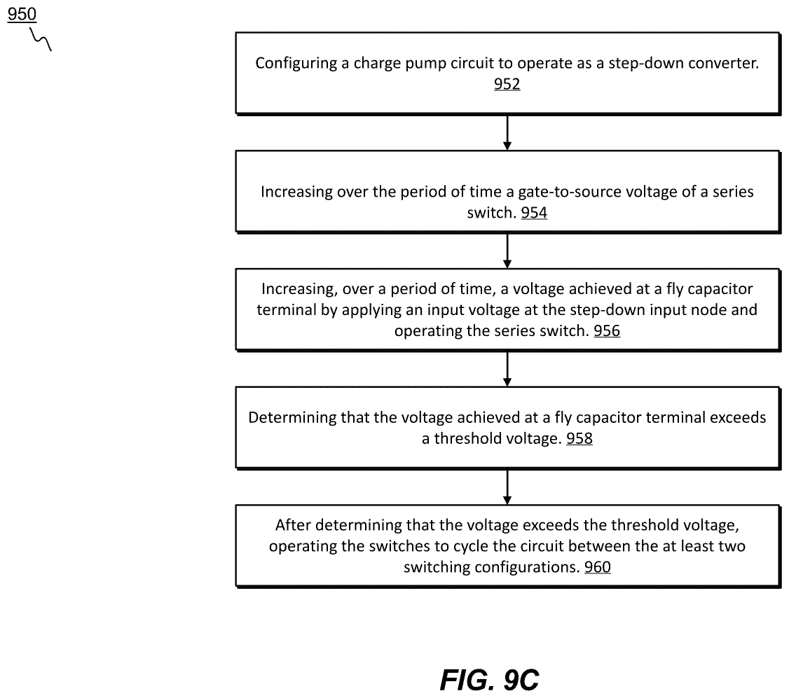

Each pair of the phase switches (P_{LA}, P_{HA}) and (P_{LB}, P_{HB}) can be operated in phases to alternately electrically connect the negative terminals n_{A}, n_{B} of the fly capacitors either to a reference voltage (e.g., electrical ground) or to the low-side terminal (voltage V_{LO}) of the switched capacitor network 100. For example, with reference to the first pair (P_{LA}, P_{HA}) of the phase switches, in a first phase φ₁ of operation (e.g., which may be implemented via a controller circuit, and/or other control components, for example, as described herein with respect to FIGS. 5A and 9A), the “low-side” phase switch P_{LA} can be turned ON and the “high-side” phase switch P_{HA} can be turned OFF to electrically connect the negative terminal n_{A} of fly capacitors C_{Fly1}, C_{Fly3}, . . . CFly(2N-1) to the reference voltage. By contrast, in a second phase φ₂ of operation, the “low-side” phase switch P_{LA} can be turned OFF and the “high-side” phase switch P_{HA} can be turned ON to electrically connect the negative terminal n_{A} of fly capacitors C_{Fly1}, C_{Fly3}, . . . C_{Fly(2N-1)} to the low-side terminal (voltage V_{LO}) of the switched capacitor network 100. The second pair (P_{LB}, P_{HB}) of the phase switches can be operated similarly to but out of phase with the first pair (P_{LA}, P_{HA}) of the phase switches. Specifically, in the first phase φ₁ of operation, the “low-side” phase switch P_{LB} can be turned OFF and the “high-side” phase switch P_{HB} can be turned ON to electrically connect the negative terminal n_{B} of fly capacitors C_{Fly2}, C_{Fly4}, . . . C_{Fly(2N-2)} to the low-side terminal (voltage V_{LO}) of the switched capacitor network 100. By contrast, in the second phase φ₂ of operation, the “low-side” phase switch P_{LB} can be turned ON and the “high-side” phase switch P_{HB} can be turned OFF to electrically connect the negative terminal n_{B} of fly capacitors C_{Fly2}, C_{Fly4}, . . . C_{Fly(2N-2)} to the reference voltage.

Each series switch Sₖ (k=2, 3, . . . 2N−1) can be turned ON to allow charge transfer between adjacent fly capacitors C_{Fly(k-1)} and C_{Flyk}, or turned OFF to restrict such charge transfer. Also, series switch S₁ can be turned ON to allow charge transfer between fly capacitor C_{Fly1} and the low-side terminal (voltage V_{LO}) of the switched capacitor network 100 or turned OFF to restrict such charge transfer, and series switch S_{2N} can be turned ON to allow charge transfer between fly capacitor C_{Fly(2N-1)} and the high-side terminal (voltage V_{HI}) of the switched capacitor network 100 or turned OFF to restrict such charge transfer. The series switches can be operated in the same phases (φ₁, φ₂) as the phase switches, such that any two adjacent series switches Sₖ₋₁ and Sₖ (k=2, 3, . . . 2N) are operated out of phase with each other. For example, series switches S₁, S₃, . . . S_{2N-1} can be turned ON during the first phase φ₁ of operation and turned OFF during the second phase φ₂ of operation. By contrast, series switches S₂, S₄, . . . S_{2N} can be turned OFF during the first phase φ₁ of operation and turned ON during the second phase φ₂ of operation. The configuration of the phase switches and the series switches during each phase (φ₁, φ₂) of operation represents a different switching configuration. It is to be understood that switched capacitor networks may be designed consistent with the present disclosure to employ additional phases (φ₃ . . . φₘ) of operation, yielding additional switching configurations, and that the teachings of the present disclosure may advantageously employed in such switched capacitor networks as well.

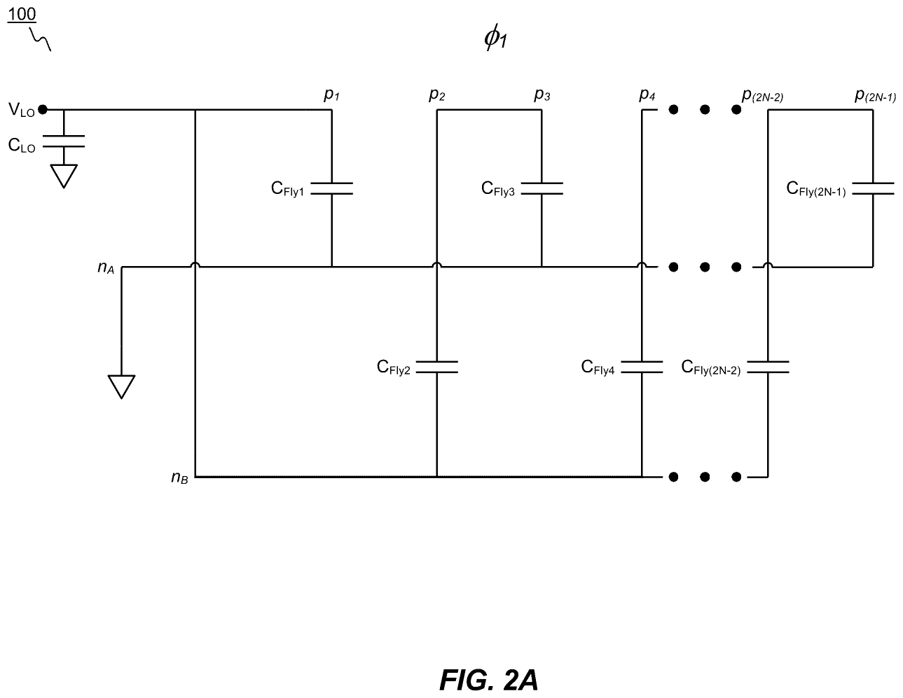

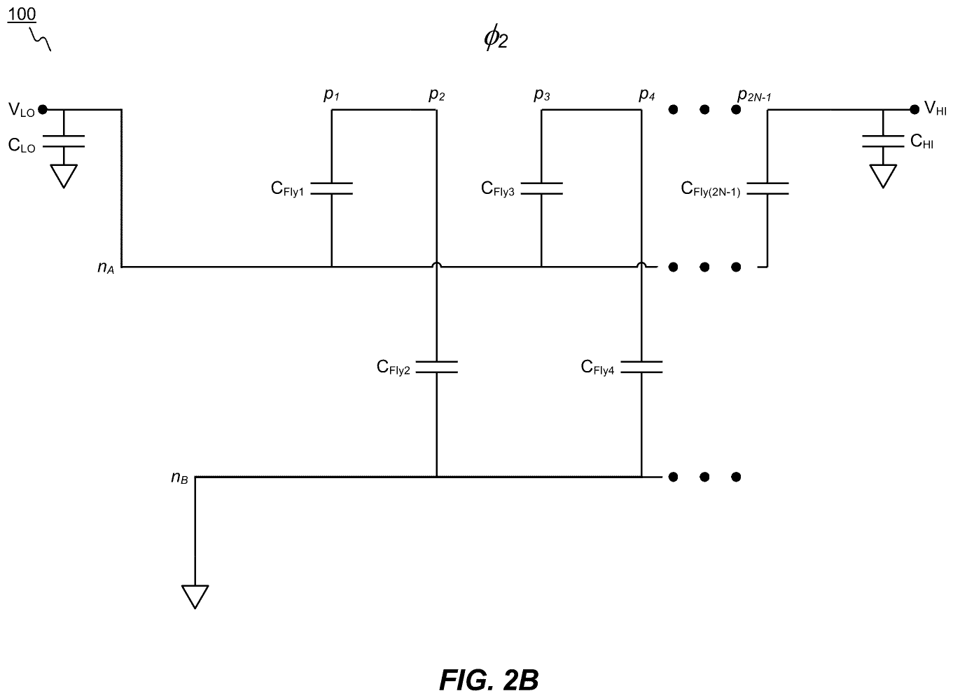

As explained below with reference to FIGS. 2A-2B, the net effect of the phased (φ₁, φ₂) operation of the series switches Sₖ (k=1, 3, . . . 2N) and the phase switches (P_{LA}, P_{LB}, P_{HA}, and P_{HB}) described above is to progressively transfer charge in a controlled manner between the fly capacitors C_{Fly1}, C_{Fly2}, . . . C_{Fly(2N-1)} in successive phases, such that in steady state the switched capacitor network 100 achieves a transformation of voltage between the low-side voltage V_{LO} and the high-side voltage V_{HI} (as either a step-up or a step-down power converter).

FIG. 1B is a circuit diagram of another example switched capacitor network 100 configured for use as a charge pump power conversion circuit. In this example embodiment, switched capacitor network 110 builds on the circuitry of the switched capacitor network 100 of FIG. 1A by including an additional row of series switches S_{1_OP}, S_{2_OP}, . . . S_{2N_OP} between the low-side terminal (voltage V_{LO}) and the high-side terminal (voltage V_{HI}), and corresponding fly capacitors C_{Fly1_OP}, C_{Fly2_OP}, . . . C_{Fly(2N-1)_OP}. But these series switches S_{1_OP}, S_{2_OP}, . . . S_{2N_OP} are turned ON and OFF in opposite phases (φ₂, φ₁) to the phases (φ₁, φ₂) of their corresponding series switches S₁, S₂, . . . S_{2N}. Also, although the fly capacitors C_{Fly1_OP}, C_{Fly2_OP}, . . . C_{Fly(2N-1)_OP} share the same phase switches P_{LA}, P_{LB}, P_{HA}, and P_{HB} as fly capacitors C_{Fly1}, C_{Fly2}, . . . C_{Fly(2N-1)}, they are connected oppositely to negative terminals n_{A} and n_{B}, Accordingly, fly capacitors C_{Fly1_OP}, C_{Fly3_OP}, . . . C_{Fly(2N-1)_OP} each have their “positive” terminals p_{1_OP}, p_{3_OP}, . . . p_{2N-1_OP} electrically connected between a pair of series switches (S_{1_OP}, S_{2_OP}), (S_{3_OP}, S_{4_OP}), . . . (S_{2N-1_OP}, S_{2N_OP}) respectively, and their “negative” terminals n_{B} all electrically connected between the second pair (P_{LB}, P_{HB}) of the phase switches. Similarly, fly capacitors C_{Fly2_OP}, C_{Fly4_OP}, . . . C_{Fly(2N-2)_OP} each have their “positive” terminals p_{2_OP}, p_{4_OP}, . . . p_{2N-2_OP} electrically connected between a pair of series switches (S_{2_OP}, S_{3_OP}), (S_{4_OP}, S_{5_OP}), . . . (S_{2N-2_OP}, S_{2N-1_OP}) respectively, and their “negative” terminals n_{A} all electrically connected between the first pair (P_{LA}, P_{HA}) of the phase switches. The term “op” may be referred to as “opposite phase.”

In like manner to the switched capacitor network 100 of FIG. 1A, in the switched capacitor network 110 of FIG. 1B, the net effect of the phased (φ₁, φ₂) operation of the series switches S_{k_OP} (k=1, 3, . . . 2N) and the phase switches (P_{LA}, P_{LB}, P_{HA}, and P_{HB}) described above is to progressively transfer charge in a controlled manner between the fly capacitors C_{Fly1_OP}, C_{Fly2_OP}, . . . C_{Fly(2N-1)_OP} in successive phases, such that in steady state operation the switched capacitor network 110 achieves a transformation of voltage between the low-side voltage V_{LO} and the high-side voltage V_{HI} (as either a step-up or a step-down power converter). Also, as discussed with respect to the switched capacitor network 100 of FIG. 1A, the switched capacitor network 110 of FIG. 1B may be reconfigurable in that the number of series switches S1/S_{1_OP}, S2/S_{2_OP}, . . . Sₖ/S_{k_OP} (or, correspondingly, the number of fly capacitors C_{Fly1}/C_{Fly1_OP}, C_{Fly2}/C_{Fly2_OP}, . . . C_{Fly(k-1)}/C_{Fly(k-1)_OP}) actually operated can be varied to provide a variable voltage transformation ratio between the low-side voltage V_{LO} and the high-side voltage V_{HI}.

FIG. 1C is a circuit diagram of another example switched capacitor network 120 configured for use as a charge pump power conversion circuit. In this example embodiment, switched capacitor network 120 builds on the circuitry of the switched capacitor network 100 of FIG. 1A by including an additional series switch S_{2N+1} between series switch S_{2N} and the high-side terminal (voltage V_{HI}), and a corresponding additional fly capacitor C_{Fly(2N)}. The additional fly capacitor C_{Fly(2N)} has its positive terminal p_{2N} electrically connected between the pair of series switches (S_{2N}, S_{2N+1}) and its negative terminal n_{B} electrically connected between the second pair (P_{LB}, P_{HB}) of the phase switches. In this example embodiment, switched capacitor network 120 operates in steady-state as a DC-DC converter that is configured to transform power between the low-side voltage V_{LO} and the high-side voltage V_{HI}, where in steady state V_{LO} and V_{HI} satisfy the mathematical relationship V_{HI}=(2N+1)×V_{LO}, N being a positive integer (i.e., 1, 2, 3, etc.). The switched capacitor network 120 of FIG. 1C, other than providing an odd voltage transformation ratio (i.e., 2N+1) rather than an even voltage transformation ratio (i.e., 2N) of the switched capacitor network 100 of FIG. 1A, operates in a similar manner (and is similarly reconfigurable) as described above with respect to the switched capacitor network 100 of FIG. 1A.

FIG. 1D is a circuit diagram of another example switched capacitor network 130 configured for use as a charge pump power conversion circuit. In a similar manner as the switched capacitor network 110 of FIG. 1B builds on the switched capacitor network 100 of FIG. 1A, in this example embodiment switched capacitor network 130 builds on the circuitry of the switched capacitor network 120 of FIG. 1C by including an additional row of series switches S_{1_OP}, S_{2_OP}, . . . S_{2N+1_OP} between the low-side terminal (voltage V_{LO}) and the high-side terminal (voltage V_{HI}), and corresponding fly capacitors C_{Fly1_OP}, C_{Fly2_OP}, . . . C_{Fly(2N)_OP}. These series switches S_{1_OP}, S_{2_OP}, . . . S_{2N+1_OP} are turned ON and OFF in opposite phases (φ₂, φ₁) to the phases (φ₁, φ₂) of their corresponding series switches S₁, S₂, . . . S_{2N+1}. Also, although the fly capacitors C_{Fly1_OP}, C_{Fly2_OP}, . . . C_{Fly(2N)_OP} share the same phase switches P_{LA}, P_{LB}, P_{HA}, and P_{HB} as fly capacitors C_{Fly1}, C_{Fly2}, . . . C_{Fly(2N)}, they are connected oppositely to negative terminals n_{A} and n_{B}, Accordingly, fly capacitors C_{Fly1_OP}, C_{Fly3_OP}, . . . C_{Fly(2N-1)_OP} each have their “positive” terminals p_{1_OP}, p_{3_OP}, . . . p_{2N-1_OP} electrically connected between a pair of series switches (S_{1_OP}, S_{2_OP}), (S_{3_OP}, S_{4_OP}), . . . (S_{2N-1_OP}, S_{2N_OP}) respectively, and their “negative” terminals n_{B} all electrically connected between the second pair (P_{LB}, P_{HB}) of the phase switches. Similarly, fly capacitors C_{Fly2_OP}, C_{Fly4_OP}, . . . C_{Fly(2N)_OP} each have their “positive” terminals p_{2_OP}, p_{4_OP}, . . . p_{2N_OP} electrically connected between a pair of series switches (S_{2_OP}, S_{3_OP}), (S_{4_OP}, S_{5_OP}), . . . (S_{2N_OP}, S_{2N+1_OP}) respectively, and their “negative” terminals n_{A} all electrically connected between the first pair (P_{LA}, P_{HA}) of the phase switches.

In like manner to the switched capacitor network 120 of FIG. 1C, in the switched capacitor network 130 of FIG. 1D, the net effect of the phased (φ₁, φ₂) operation of the series switches S_{k_OP} (k=1, 3, . . . 2N+1) and the phase switches (P_{LA}, P_{LB}, P_{HA}, and P_{HB}) described above is to progressively transfer charge in a controlled manner between the fly capacitors C_{Fly1_OP}, C_{Fly2_OP}, . . . C_{Fly(2N)_OP} in successive phases, such that in steady state operation the switched capacitor network 130 achieves a transformation of voltage between the low-side voltage V_{LO} and the high-side voltage V_{HI} (as either a step-up or a step-down power converter). Also, as discussed with respect to the switched capacitor networks 100-120 of FIGS. 1A-1C, the switched capacitor network 130 of FIG. 1D may be reconfigurable in that the number of series switches S1/S_{1_OP}, S2/S_{2_OP}, . . . Sₖ/S_{k_OP} (or, correspondingly, the number of fly capacitors C_{Fly1}/C_{Fly1_OP}, C_{Fly2}/C_{Fly2_OP}, . . . C_{Fly(k-1)}/C_{Fly(k-1)_OP}) actually operated can be varied to provide a variable voltage transformation ratio between the low-side voltage V_{LO} and the high-side voltage V_{HI}.

The operation of switched capacitor networks 100-130 in step-up conversion mode to transform a low-side input voltage V_{LO} into a high-side output voltage V_{HI} shall now be described with reference to FIGS. 2A-2B. For simplicity, the operation of switched capacitor network 100 of FIG. 1A will be described in detail, but it is to be understood that the switched capacitor networks 110-130 of FIGS. 1B-1D also follow similar operating principles, consistent with their respective circuit topologies and phased operation described above with respect to FIGS. 1A-1D.

With reference to FIG. 1A, upon switching into the first phase φ₁ of operation, the low-side phase switch P_{LA} is turned ON and the high-side phase switch P_{HA} is turned OFF to electrically connect the negative terminal n_{A} of fly capacitors C_{Fly1}, C_{Fly3}, . . . C_{Fly(2N-1)} to the reference voltage. By contrast, the low-side phase switch P_{LB} is turned OFF and the high-side phase switch P_{HB} is turned ON to electrically connect the negative terminal n_{B} of fly capacitors C_{Fly2}, C_{Fly4}, . . . C_{Fly(2N-2)} to the low-side terminal (voltage V_{LO}) of the switched capacitor network 100. Further, in the first phase φ₁ of operation, the odd-numbered series switches S₁, S₃, . . . S_{2N-1} are turned ON and the even-numbered series switches S₂, S₄, . . . S_{2N} are turned OFF. Accordingly, in the first phase φ₁ of operation, assuming that the voltage drop across the individual switches is insignificant (e.g., they are highly enhanced MOSFET switches), the switched capacitor network 100 forms an effective circuit as shown in FIG. 2A.

As shown in FIG. 2A, upon switching into the first phase φ₁ of operation, the positive terminal p₁ of the fly capacitor C_{Fly1} is electrically connected to the low-side terminal (voltage V_{LO}) of the switched capacitor network 100, resulting in a charge transfer current into the fly capacitor C_{Fly1}. Further, the negative terminal n_{B} of the fly capacitors C_{Fly2}, C_{Fly4}, . . . C_{Fly(2N-2)} is also electrically connected to the low-side terminal (voltage V_{LO}), thus boosting the voltages at the positive terminals p₂, p₄, . . . p_{(2N-2)} of the fly capacitors C_{Fly2}, C_{Fly4}, . . . C_{Fly(2N-2)} by the low-side input voltage V_{LO}. Because in the first phase φ₁ of operation the positive terminals p₂, p₄, . . . p_{(2N-2)} are electrically connected to the positive terminals p₃, p₅, . . . p_{(2N-1)} respectively, this results in a charge transfer current from the fly capacitors C_{Fly2}, C_{Fly4}, . . . C_{Fly(2N-2)} into the fly capacitors C_{Fly3}, C_{Fly5}, . . . C_{Fly(2N-1)}. Thus, during the first phase φ₁ of operation, charge is transferred into fly capacitors C_{Fly1}, C_{Fly3}, . . . C_{Fly(2N-1)}.

Returning to FIG. 1A, upon switching into the second phase φ₂ of operation, the low-side phase switch P_{LA} is turned OFF and the high-side phase switch P_{HA} is turned ON to electrically connect the negative terminal n_{A} of fly capacitors C_{Fly1}, C_{Fly3}, . . . C_{Fly(2N-1)} to the low-side terminal (voltage V_{LO}) of the switched capacitor network 100. By contrast, the low-side phase switch P_{LB} is turned ON and the high-side phase switch P_{HB} is turned OFF to electrically connect the negative terminal n_{B} of fly capacitors C_{Fly2}, C_{Fly4}, . . . C_{Fly(2N-2)} to the reference voltage. Further, in the second phase φ₂ of operation, the odd-numbered series switches S₁, S₃, . . . S_{2N-1} are turned OFF and the even-numbered series switches S₂, S₄, . . . S_{2N} are turned ON. Accordingly, in the second phase φ₂ of operation, assuming that the voltage drop across the individual switches is insignificant (e.g., they are highly enhanced MOSFET switches), the switched capacitor network 100 forms an effective circuit as shown in FIG. 2B.

As shown in FIG. 2B, upon switching into the second phase φ₂ of operation, the negative terminal n_{A} of the fly capacitors C_{Fly1}, C_{Fly3}, . . . C_{Fly(2N-1)} is electrically connected to the low-side terminal (voltage V_{LO}) of the switched capacitor network 100, thus boosting the voltages at the positive terminals p₁, p₃, . . . p_{(2N-1)} of the fly capacitors C_{Fly1}, C_{Fly3}, . . . C_{Fly(2N-1)} by the low-side input voltage V_{LO}. Because in the second phase φ₁ of operation the positive terminals p₁, p₃, . . . p_{(2N-1)} are electrically connected to the positive terminals p₂, p₄, . . . p_{(2N-2)} and the high-side terminal (voltage V_{HI}) of the switched capacitor network 100 respectively, this results in a charge transfer current from the fly capacitors C_{Fly1}, C_{Fly3}, . . . C_{Fly(2N-1)} into the fly capacitors C_{Fly2}, C_{Fly4}, . . . C_{Fly(2N-2)}. Thus, during the second phase φ₂ of operation, charge is transferred into fly capacitors C_{Fly2}, C_{Fly4}, . . . C_{Fly(2N-2)}.

As can be seen from FIGS. 2A-2B, the net effect of the phased (φ₁, φ₂) operation of the series switches Sₖ (k=1, 3, . . . 2N) and the phase switches (P_{LA}, P_{LB}, P_{HA}, and P_{HB}) described above is to progressively transfer charge in a controlled manner between the fly capacitors C_{Fly1}, C_{Fly2}, . . . C_{Fly(2N-1)} in successive phases, such that in steady state the switched capacitor network 100 achieves a transformation of voltage from the low-side terminal (voltage V_{LO}) to the high-side terminal (voltage V_{HI}) when operated as a step-up power converter.

Further, operation of the switched capacitor network 100 as a step-down power converter follows a similar operating principle of progressively transferring charge in a controlled manner between the fly capacitors C_{Fly1}, C_{Fly2}, . . . C_{Fly(2N-1)} in successive phases, such that in steady state the switched capacitor network 100 achieves a transformation of voltage from the high-side voltage V_{HI} to the low-side voltage V_{LO}. For example, with reference to FIG. 2B, upon switching into the second phase φ₂ of operation, the high-side terminal (voltage V_{HI}) and positive terminals p_{(2N-2)} . . . p₄, p₂ of fly capacitors C_{Fly(2N-2)} . . . C_{Fly4}, C_{Fly2} are electrically connected to positive terminals p_{(2N-1)} . . . p₃, p₁ of fly capacitors C_{Fly(2N-1)} . . . C_{Fly3}, C_{Fly1} respectively, which in turn are connected in series with output capacitance C_{LO} associated with the low-side terminal (voltage V_{LO}). This results in charge redistribution yielding a charge transfer current from the fly capacitors C_{Fly(2N-2)} . . . C_{Fly4}, C_{Fly2} distributed to the C_{Fly(2N-1)} . . . C_{Fly3}, C_{Fly1} and the output capacitance C_{LO}. Further, with reference to FIG. 2A, upon switching into the first phase φ₁ of operation, the positive terminals p_{(2N-1)}. p₅, p₃ of fly capacitors C_{Fly(2N-1)} . . . C_{Fly3}, C_{Fly1} are electrically connected to positive terminals p_{(2N-2)}. p₄, p₂ of fly capacitors C_{Fly(2N-2)} . . . C_{Fly4}, C_{Fly2} respectively, which in turn are connected in series with output capacitance C_{LO} associated with the low-side terminal (voltage V_{LO}). This again results in charge redistribution yielding a charge transfer current from the fly capacitors C_{Fly(2N-1)} . . . C_{Fly5}, C_{Fly3} distributed to the C_{Fly(2N-2)} . . . C_{Fly4}, C_{Fly2} and also charge transfer current from the fly capacitor C_{Fly1} to the output capacitance C_{LO}. The net effect of this phased (φ₁, φ₂) operation is to progressively transfer charge in a controlled manner between the fly capacitors C_{Fly1}, C_{Fly2}, . . . C_{Fly(2N-1)} in successive phases, such that in steady state the switched capacitor network 100 achieves a transformation of voltage from the high-side input terminal (voltage V_{HI}) to the low-side output terminal (voltage V_{LO}) when operated as a step-down power converter.

The inventors here, however, have recognized certain problems associated with such operation of the switched capacitor networks 100-130 of FIGS. 1A-1D in step-up and/or step-down conversion mode. As discussed above, the switching between the first phase φ₁ and the second phase φ₂ of operation results in charge transfer currents (also referred to as switching currents). In particular, before the switched capacitor network has achieved steady state operation, these switching currents can be undesirably high, which can exceed the maximum current ratings of the components of the switched capacitor network and/or other components of the charge pump power conversion circuit, potentially causing them damage. This problem can be particularly exacerbated in high-power applications such as power converters for data centers, servers, artificial intelligence (AI) hardware processors, and other high-performance computing systems.

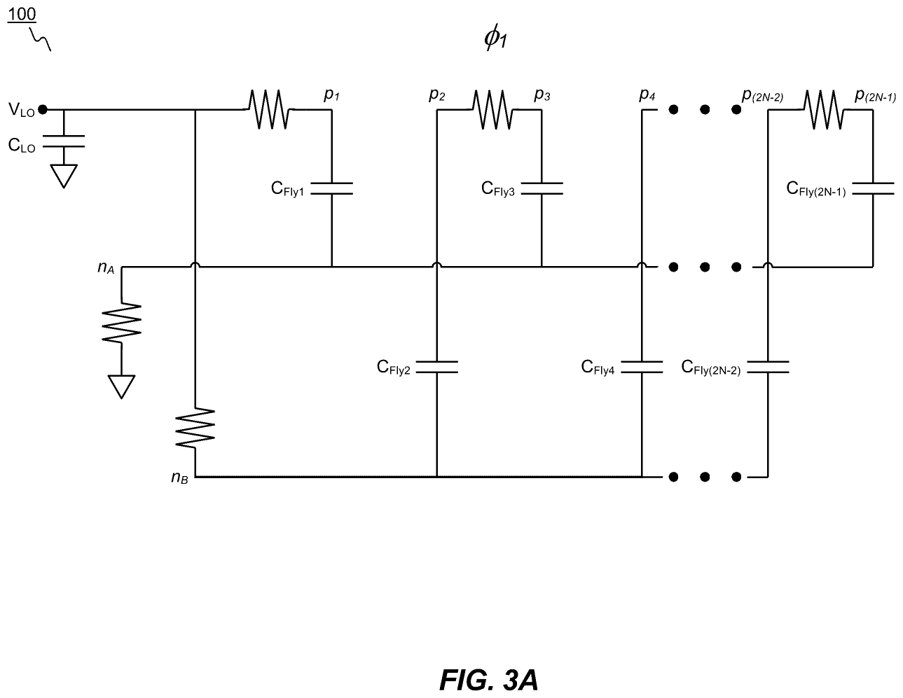

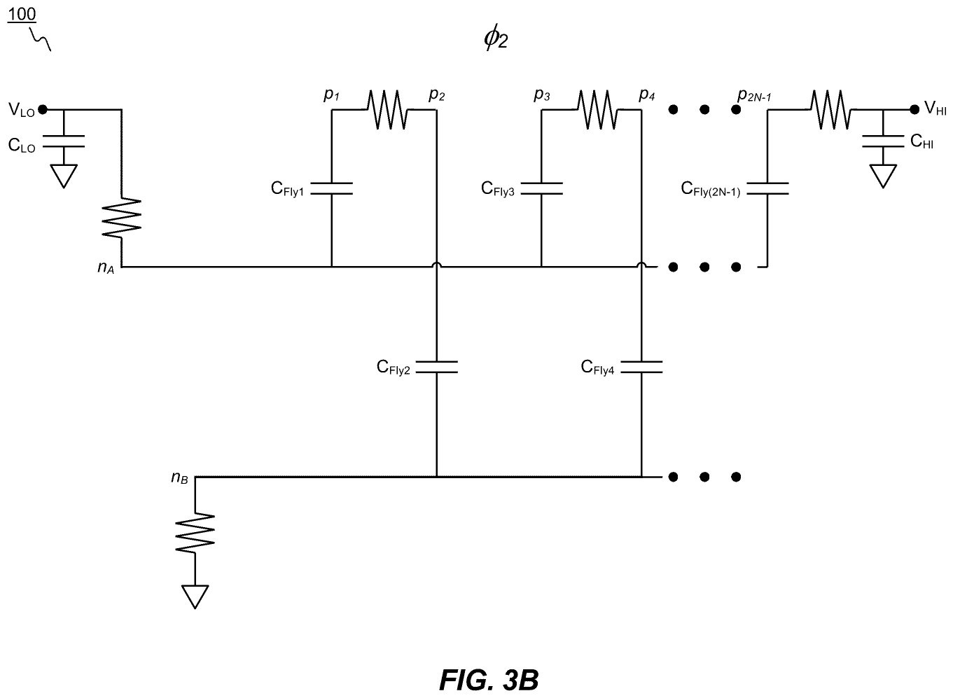

In situations where the switched capacitor network (like the one shown in FIG. 1A) uses MOSFET switches, one potential option to mitigate the undesirably high switching currents is to only partially enhance the MOSFET switches into a more resistive state (e.g., operating the MOSFETs in their saturation region and/or using a lower gate-to-source voltage than at steady state) while the switched capacitor network has not yet achieved steady state operation. In this potential option, the switched capacitor network 100 of FIG. 1A forms an effective circuit in the first phase φ₁ of operation as shown in FIG. 3A, and an effective circuit in the second phase φ₂ of operation as shown in FIG. 3B. The partially enhanced MOSFET switches would result in reduced voltages, and thus reduced charge transfer currents, driving the charge transfer between the fly capacitors C_{Fly1}, C_{Fly2}, . . . C_{Fly(2N-1)} in the switching network. This potential option may not be workable, however, in the situation where the I-V characteristics of the specific MOSFET switches to be employed in the switched capacitor network are unknown during the design of the charge pump power conversion circuit including its controllers. But this situation can sometimes be the case when designing for high-power applications such as power converters for data centers, servers, artificial intelligence (AI) hardware processors, and other high-performance computing systems, where a charge pump power conversion integrated circuit that is shipped to an end-user may not include the MOSFET switches, which instead may be installed afterwards on-site and selected based on the particular requirements of the end-user application. For example, a charge pump power conversion integrated circuit that is shipped to an end-user may not include the MOSFET switches if the thermal energy dissipation requirements of the high-power application associated with the MOSFET switches exceed what the integrated circuit of relatively small geometric dimensions can provide.

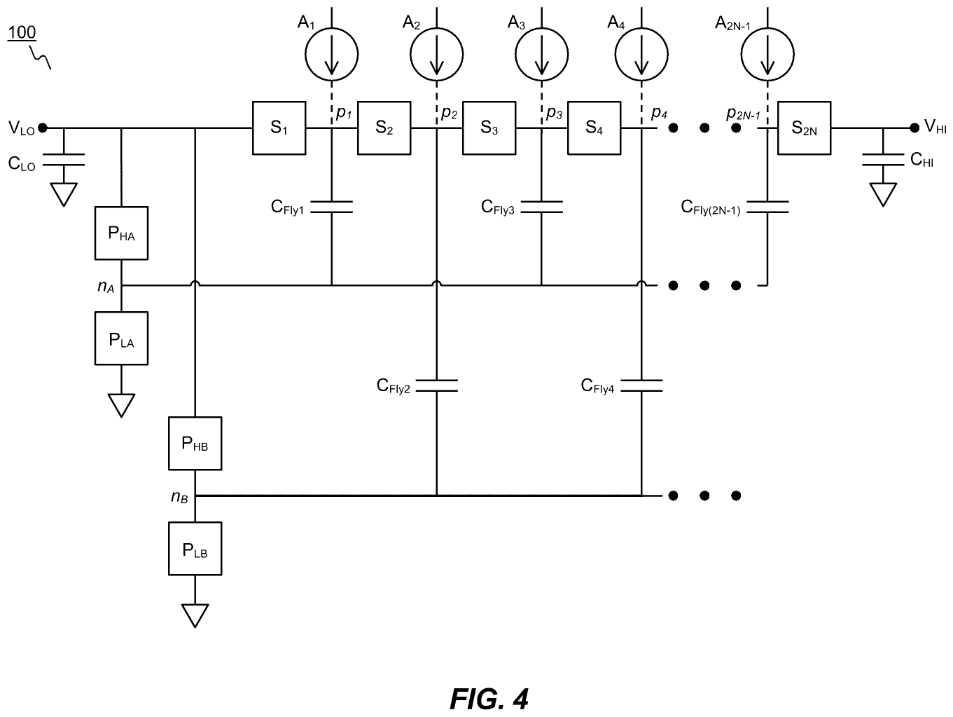

Another potential option to mitigate the undesirably high switching currents is to, instead of charging the fly capacitors by operating the switches in the switched capacitor network, provide separate current sources to pre-charge the fly capacitors close to their steady-state charge states before commencing switching operations, as shown in FIG. 4. This potential option may not be workable, however, in the situation where the capacitance values of the fly capacitors are unknown during the design of the charge pump power conversion circuit including its controllers, or the switched capacitor circuit is reconfigurable with a variable voltage transformation ratio, as discussed above. Also, in the case of pre-charging the fly capacitors for subsequently operating the switched capacitor network as a step-up power converter, the voltage sources for operating the separate current sources may be higher than the input voltage available to the switched capacitor network.

Embodiments of the present disclosure provide improved methods for powering up a charge pump power conversion circuit, when operating as either a step-up or a step-down power converter, in manners that reduce switching currents and also do not require prior knowledge of the characteristics of the switches (e.g., MOSFET switches) or the capacitances of the fly capacitors to be employed in the switched capacitor network.

### Step-up Conversion Mode

In accordance with various embodiments, improved methods for powering up switched capacitor networks 100-130 to be operated in step-up conversion mode to transform a low-side input voltage V_{LO} into a high-side output voltage V_{HI} will now be described with reference to FIGS. 5A-5D and FIGS. 6-8. For simplicity, the methods will be described in detail with respect to switched capacitor network 100 of FIG. 1A, but it is to be understood that these methods apply equally to the switched capacitor networks 110-130 of FIGS. 1B-1D.

The example switched capacitor network 500 of FIG. 5A may be implemented using the same or similar components as previously described with respect to the switched capacitor network 100 of FIG. 1A, including a plurality of interconnected switches and capacitors. The switched capacitor network 500 further includes control circuitry, such as controller circuit 520 in the illustrated embodiment, couplable to the plurality of switches and plurality of fly capacitors forming a network of interconnected switches and fly capacitors. In various embodiments, the controller circuit 520 may include analog circuitry, digital logic, firmware, a processor or controller, software, and/or other components as appropriate. In some implementations, the controller circuit 520 includes a clock signal generator, level shifter circuit, gate driver circuit and/or other circuity and logic described herein with respect to FIGS. 1-10.

The controller circuit 520 is configurable to operate the switched capacitor network 500 in a step-up conversion mode 530, including associated switch control circuitry operable to control the ON and OFF states of the switches to cycle the switched capacitor network 500 between at least two switching configurations including a first phase φ₁ of operation and a second phase φ₂ of operation. The step-up conversion mode 530 further includes soft-start circuitry 534 operable to control one or more of the switches in a partially enhanced mode.

In some embodiments, the soft-start circuitry 534 is operable to implement a phased bootstrapping process, as described herein, to safely power up the switched capacitor network 500 for step-up conversion mode. In a first phase, for example, the power switches may be controlled to define a path from the input source V_{LO} to the positive terminal of a first fly capacitor C_{FLY1} to ground (e.g., through negative terminal N_{A}). The switches in this path, including a first series switch S₁, which is connected in series between the input source V_{LO} and the positive terminal of the first fly capacitor C_{Fly1}, and a first low side phase switch P_{LA}, may be fully enhanced to charge the fly capacitor C_{Fly1} using the input source V_{LO}.

In a second phase, the soft-start circuitry 534 is configured to define a path connecting the positive terminal of the first fly capacitor C_{Fly1} to a positive terminal of a second fly capacitor C_{Fly2}. The negative terminal of the first fly capacitor C_{Fly1} is connected to the input source V_{LO} through a high side phase switch P_{HA} that is partially enhanced via a ramp gate voltage, limiting the current flow.

In the illustrated embodiment, the controller circuit 520 is operable to control the ON/OFF state of each power switch and phase switch the plurality of switches to cycle between the first phase of operation and the second phase of operation in accordance with a duty cycle. During the soft-start process, the high-side phase switches P_{HA} and P_{HB} are initially partially enhanced when turned ON in accordance with the duty cycle, and the enhancement factor k is ramped up over time, as explained in further detail herein.

With reference to FIG. 5A, in a first phase φ₁ of operation, the low-side phase switch P_{LA} is turned ON and the high-side phase switch P_{HA} is turned OFF to electrically connect the negative terminal n_{A} of fly capacitors C_{Fly1}, C_{Fly3}, . . . C_{Fly(2N-1)} to the reference voltage. By contrast, the low-side phase switch P_{LB} is turned OFF and the high-side phase switch P_{HB} is turned ON to electrically connect the negative terminal n_{B} of fly capacitors C_{Fly2}, C_{Fly4}, . . . C_{Fly(2N-2)} to the low-side terminal (voltage V_{LO}) of the switched capacitor network 500. As described herein, the high-side phase switch P_{HB} may be turned ON and partially enhanced (e.g., via k_{HB}) during the soft-start process and turned ON and fully enhanced during standard operation. Further, in the first phase φ₁ of operation, the odd-numbered series switches S₁, S₃, . . . S_{2N-1} are turned ON and the even-numbered series switches S₂, S₄, . . . S_{2N} are turned OFF. Accordingly, in the first phase φ₁ of operation, the switched capacitor network 500 forms an effective circuit as shown in FIG. 5B.

As shown in FIG. 5B, upon switching into the first phase φ₁ of operation, the positive terminal p₁ of the fly capacitor C_{Fly1} is electrically connected to the low-side terminal (voltage V_{LO}) of the switched capacitor network 500, resulting in a charge transfer current into the fly capacitor C_{Fly1}, and the voltage at the positive terminal p₁ of the fly capacitor C_{Fly1} being brought up to the low-side voltage V_{LO}. Further, the negative terminal n_{B} of the fly capacitors C_{Fly2}, C_{Fly4}, . . . C_{Fly(2N-2)} is also electrically connected to the low-side terminal (voltage V_{LO}), thus boosting the voltages at the positive terminals p₂, p₄, . . . p_{(2N-2)} of the fly capacitors C_{Fly2}, C_{Fly4}, . . . C_{Fly(2N-2)} by k_{HB}*V_{LO}, where k_{HB} (0<=k_{HB}<=1) is an enhancement factor of the high-side phase switch P_{HB} during the current first phase φ₁ of operation. In some embodiments, the value of k_{HB} may be increased during successive first phases φ₁ of operation. For example, if j represents the cycle number, i.e., a count of the number of first phases φ₁ of operation, the enhancement factor k_{HB} may be incremented by a fixed amount until it reaches full or maximum desired enhancement (e.g., k_{HB}=1), for example k_{HBj}={0.1; 0.2; 0.3; 0.4; 0.5; 0.6; 0.7; 0.8; 0.9; 1.0} or k_{HBj}={0; 0.2; 0.4; 0.6; 0.8}. Because in the first phase φ₁ of operation the positive terminals p₂, p₄, . . . p_{(2N-2)} are electrically connected to the positive terminals p₃, p₅, . . . p_{(2N-1)} respectively, this results in a charge transfer current from the fly capacitors C_{Fly2}, C_{Fly4}, . . . C_{Fly(2N-2)} into the fly capacitors C_{Fly3}, C_{Fly5}, . . . C_{Fly(2N-1)}. Thus, during the first phase φ₁ of operation, charge is transferred into fly capacitors C_{Fly1}, C_{Fly3}, . . . C_{Fly(2N-1)}.

Returning to FIG. 5A, upon switching into the second phase φ₂ of operation, the low-side phase switch P_{LA} is turned OFF and the high-side phase switch P_{HA} is turned ON to electrically connect the negative terminal n_{A} of fly capacitors C_{Fly1}, C_{Fly3}, . . . C_{Fly(2N-1)} to the low-side terminal (voltage V_{LO}) of the switched capacitor network 500. As described herein, the high-side phase switch P_{HA} may be turned ON and partially enhanced (e.g., via k_{HA}) during the soft-start process and turned ON and fully enhanced during standard operation. By contrast, the low-side phase switch P_{LB} is turned ON and the high-side phase switch P_{HB} is turned OFF to electrically connect the negative terminal n_{B} of fly capacitors C_{Fly2}, C_{Fly4}, . . . C_{Fly(2N-2)} to the reference voltage. Further, in the second phase φ₂ of operation, the odd-numbered series switches S₁, S₃, . . . S_{2N-1} are turned OFF and the even-numbered series switches S₂, S₄, . . . S_{2N} are turned ON. Accordingly, in the second phase φ₂ of operation, the switched capacitor network 500 forms an effective circuit as shown in FIG. 5C.

As shown in FIG. 5C, upon switching into the second phase φ₂ of operation, the negative terminal n_{A} of the fly capacitors C_{Fly1}, C_{Fly3}, . . . C_{Fly(2N-1)} is electrically connected to the low-side terminal (voltage V_{LO}) of the switched capacitor network 500, thus boosting the voltages at the positive terminals p₁, p₃, . . . p_{(2N-1)} of the fly capacitors C_{Fly1}, C_{Fly3}, . . . C_{Fly(2N-1)} by k_{HA}*V_{LO}, where k_{HA} (0<=k_{HA}<=1) is an enhancement factor of the high-side phase switch P_{HA} during the current second phase φ₂ of operation. In some embodiments, the value of k_{HA} may be increased during successive second phases φ₂ of operation. For example, if j represents the cycle number, i.e., a count of the number of second phases φ₂ of operation, the enhancement factor k_{HA} may be incremented by a fixed amount until it reaches full or maximum desired enhancement (e.g., k_{HA}=1), for example k_{HAj}={0.1; 0.2; 0.3; 0.4; 0.5; 0.6; 0.7; 0.8; 0.9; 1.0} or k_{HAj}={0; 0.2; 0.4; 0.6; 0.8}. Because in the second phase φ₂ of operation the positive terminals p₁, p₃, . . . p_{(2N-1)} are electrically connected to the positive terminals p₂, p₄, . . . p_{(2N-2)} and the high-side terminal (voltage V_{HI}) of the switched capacitor network 500 respectively, this results in a charge transfer current from the fly capacitors C_{Fly1}, C_{Fly3}, . . . C_{Fly(2N-1)} into the fly capacitors C_{Fly2}, C_{Fly4}, . . . C_{Fly(2N-2)}. Thus, during the second phase φ₂ of operation, charge is transferred into fly capacitors C_{Fly2}, C_{Fly4}, . . . C_{Fly(2N-2)}.

It will be appreciated that the switched capacitor network 500 of FIG. 5A is an example step-up charge pump power conversion circuit presented for illustrative purposes and that the teachings of the present disclosure may be applied to various step-up charge pump configurations (e.g., 2× charge pump, a 3× charge pump, etc.) with corresponding numbers and configurations of switches and capacitors, as appropriate. For example, during operation of a 3× bootstrapping charge pump implementation, the first phase φ₁ of operation may be configurable to charge a first fly capacitor C_{Fly1} to V_{LO}, the second phase φ₂ of operation may be configurable to charge the second fly capacitor C_{Fly2} to 2*V_{LO}, and a next phase of operation (e.g., the first phase φ₁ of operation again) may be configurable to charge the third fly capacitor to C_{Fly3} to 3*V_{LO} for output.

In various embodiments, the voltage applied to the fly capacitors of a 3× charge pump conversion circuit may be gradually ramped up during the soft-start process through enhancement factors applied to phase switches P_{HA} and P_{HB}, respectively. The enhancement factor(s) of the phase switches P_{HA} and P_{HB} may be selected to safely pre-charge each of the fly capacitors during the soft-start process. For example, in a 3× charge pump configuration a fraction of the input source voltage V_{LO} may be initially applied to the first fly capacitor C_{FLY1} and gradually ramped up to V_{LO} while cycling between operating phases. While ramping up the voltage V_{C1} at the first fly capacitor C_{FLY1}, the second fly capacitor C_{FLY2} may settle at approximately 2×V_{C1}, and the third fly capacitor C_{FLY3} may settle at approximately 3×V_{C1}. Thus, as an enhancement factor k is ramped up, the voltage at the second fly capacitor and third fly capacitor (and any additional capacitors in an nx charge pump configuration, where n>3) will ramp up with k until their respective voltages settle at approximately 2×V_{LO} and 3×V_{LO}, respectively.

In various embodiments, the value k may be increased each switching phase and/or cycle. In some embodiments, a soft-start process for an nx charge pump may maintain a value k across a plurality of switching phases and/or cycles to slowly ramp up the capacitors to a steady state before increasing k. In some embodiments, the switched capacitor network 500 may operate in more than two phases, including fully enhanced and partially enhanced phases, that may be applied to control the startup process for higher order conversion ratios. For example, the soft-start process may include a fully enhanced phase (e.g., to charge the first fly capacitor) and partially enhanced phases to ramp up voltages of the remaining fly capacitors.

Referring to FIG. 5D, a process 550 for powering up a step-up charge pump power conversion circuit will be described in accordance with one or more embodiments. The process 550 may be implemented by controller circuit 520, which may also be configured to execute process 950 of FIG. 9C for powering up a step-down charge pump power conversion circuit and/or one or more other processes, including other processes described herein with reference to FIGS. 1-11.

The process 550 includes, in block 552, configuring a charge pump power conversion circuit to operate in a step-up conversion mode. In various embodiments, the charge pump power conversion circuit includes a network of interconnected switches and fly capacitors, the interconnected switches operable to cycle the network between at least two switching configurations. A first switch of the switches may be connected to a fly capacitor terminal and a step-up input node of the charge pump power conversion circuit.

In some embodiments, the first switch includes a first MOSFET switch, a drain terminal of the first MOSFET switch is connected to the step-up input node of the charge pump power conversion circuit, and a source terminal of the first MOSFET switch is connected to the fly capacitor terminal.

In block 554, the process 550 includes charging a first fly capacitor by operating fully enhanced switches to provide a path from the input source to the first fly capacitor, and from the first fly capacitor to ground.

In block 556, the process 550 includes charging a second fly capacitor by connecting a positive terminal of the second fly capacitor to the positive terminal of the first fly capacitor and the negative terminal of the first fly capacitor to the input source via a partially enhanced switch.

In block 558, the process 550 includes increasing the gate voltage of the phase switches during the bootstrapping/soft-start phase to gradually increase the output voltage V_{HI} to a steady state. In some embodiments, this may include increasing over the period of time a gate-to-source voltage of the first MOSFET switch during the ON state, while operating the switches to transition the network between the at least two switching configurations. In some embodiments, a gate driver circuit may be coupled to a gate terminal of the first MOSFET switch, and the process 550 may further include configuring a voltage output of the driver circuit to be the controlled via a variable current source.

In some embodiments, the switches further include other MOSFET switches, and the process 550 further includes increasing over the period of time the gate-to-source voltage of the first MOSFET switch during its ON state. The other MOSFET switches may be operated at their respective maximum rated gate-to-source voltages during their respective ON states over the period of time. In block 560, the process 550 includes operating the switches to cycle the network between the at least two switching configurations in a step-up conversion mode.

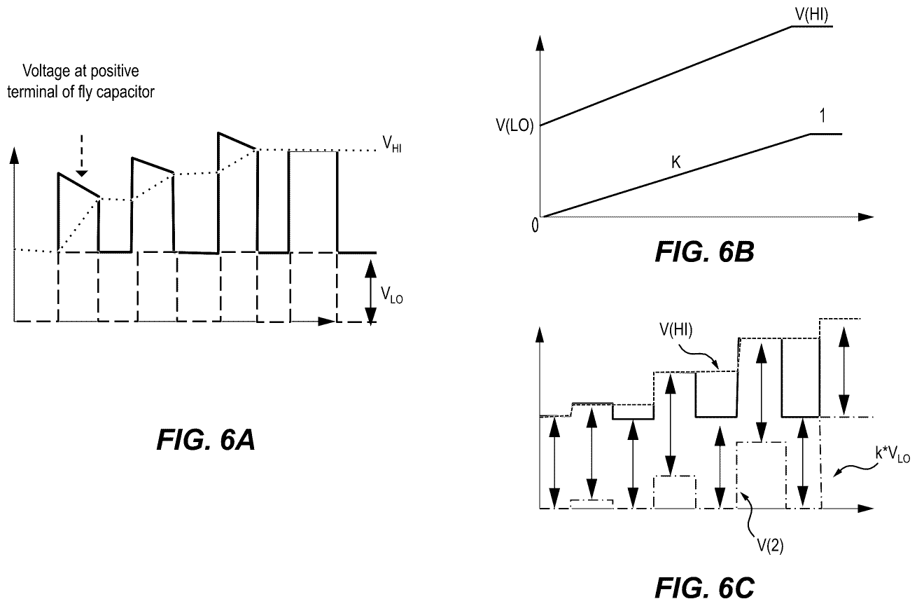

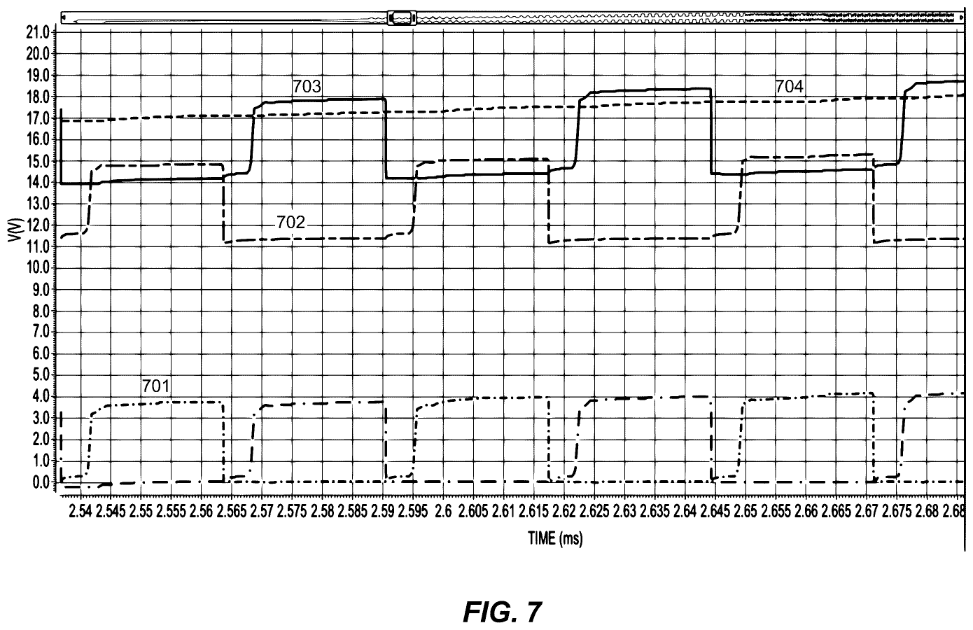

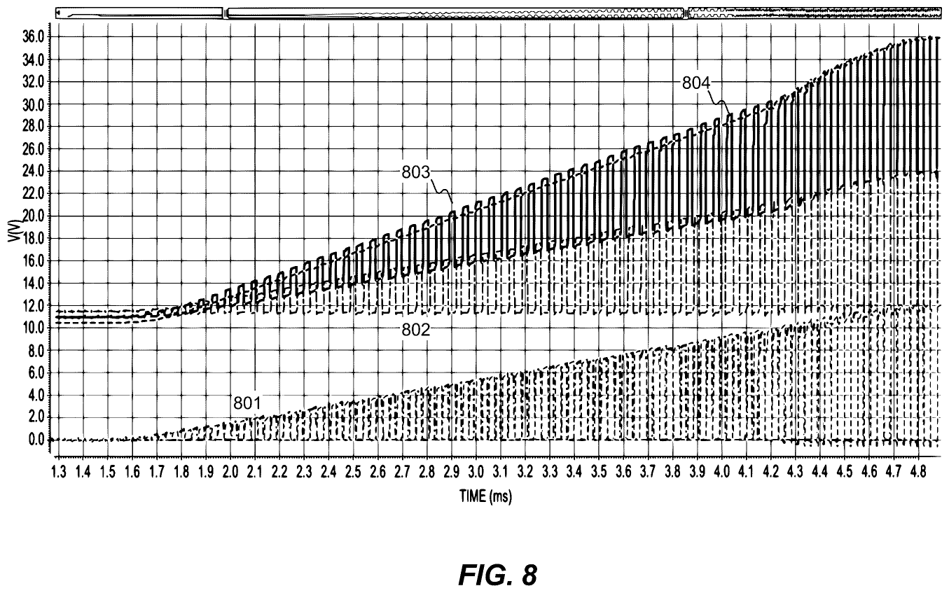

FIG. 6A, FIG. 6C, FIG. 7, and FIG. 8 illustrate the effect of the enhancement factor of the high-side phase switches P_{HB} and/or P_{HA} during the first and second phases (φ₁, φ₁) of operation respectively. FIG. 6A provides an example graph illustrating the voltages generated by the switched capacitor network 100 of FIG. 1A, which uses fully enhanced switches, whereas FIG. 6C provides an example graph illustrating the voltages generated by the switched capacitor network 500, which uses high-side phase switches P_{HA} and P_{HB} that are initially partially enhanced, with their respective enhancement factors k_{HA} and k_{HB} ramped up over time, each as shown in FIG. 6B. For example, in a 2× charge pump configuration V(HI) settles at 2×V(LO) when K=1, in a 3× charge pump configuration V(HI) settles at 3×V(LO) when K=1, and in an n× charge pump configuration V(HI) settles at n×V(LO) when K=1. FIG. 7 and FIG. 8 are examples graphs showing the results of a computer simulation of the start-up a 3× voltage transformation ratio switched capacitor network like switched capacitor network 500, operating as a step-up power converter.

As shown in FIG. 1A, during the first phase φ₁ of operation of the switched capacitor network 100 of FIG. 1A, the negative terminal n_{B} of the fly capacitors C_{Fly2}, C_{Fly4}, . . . C_{Fly(2N-2)} is effectively directly electrically connected to the low-side terminal (voltage V_{LO}), thus boosting the voltages at the positive terminals p₂, p₄, . . . p_{(2N-2)} of the fly capacitors C_{Fly2}, C_{Fly4}, . . . C_{Fly(2N-2)} by the full voltage amount of V_{LO}, as depicted in FIG. 6A. This results in higher switching currents than the scenario shown in FIG. 5B and FIGS. 6B-6C, related to switched capacitor network 500. In the scenario shown in FIG. 5B and FIGS. 6B-6C, the negative terminals n_{A} and n_{B} of the fly capacitors C_{Fly2}, C_{Fly4}, . . . C_{Fly(2N-2)} are only boosted by k*V_{LO}, as shown in FIG. 5B and FIG. 6C, thus boosting the voltages at positive terminals p₂, p₄, . . . p_{(2N-2)} of the fly capacitors C_{Fly2}, C_{Fly4}, . . . C_{Fly(2N-2)} only by k*V_{LO}, where k (0<=k<=1), and thereby resulting in lower switching currents.

As shown in FIG. 6B and FIG. 6C, with successive cycles of operation, the voltages at the positive terminals p₁, p₂, . . . p_{(2N-1)} of the fly capacitors C_{Fly1}, C_{Fly2}, . . . C_{Fly(2N-1)} and the voltage at the high-side terminal progressively increase. Accordingly, the enhancement factors k_{HA} and k_{HB} of the high-side phase switches P_{HA} and P_{HB} may be ramped up over time as shown in FIG. 6B, and the voltages at the negative terminals n_{A} and n_{B} boosted by increasingly higher values of k*V_{LO} (as shown in FIG. 6C), without undesirably increasing the switching currents during successive phases (φ₁, φ₂) of operation. Similarly, trace 701 in FIG. 7 and trace 801 in FIG. 8 depict the enhancement factors of the high-side phase switches being ramped up over time, resulting in the voltages at the negative terminals n_{A} and n_{B} boosted by increasingly higher values of k*V_{LO}. Traces 702/802 and 703/803 show the voltages at the positive terminals of the fly capacitors in the switched capacitor network progressively increasing over time, and trace 704/804 show the voltage at the high-side terminal gradually increasing the steady state value (V_{HI}) over successive cycles of operation.

Accordingly, the phased (φ₁, φ₂) operation of the series switches Sₖ (k=1, 3, . . . 2N) and the phase switches (P_{LA}, P_{LB}, P_{HA}, and P_{HB}) described above with respect to FIG. 5A progressively transfers charge in a controlled manner between the fly capacitors C_{Fly1}, C_{Fly2}, . . . C_{Fly(2N-1)} in successive phases. By gradually increasing the voltage of the phase switches as disclosed herein during a bootstrapping/soft-start phase, the output voltage V_{HI} increases slowly providing a safe startup of the switched capacitor network 500. The gradual transformation of voltage from the low-side terminal (voltage V_{LO}) to the high-side terminal (voltage V_{HI}) when operated as a step-up power converter, facilitates safe startup of the switched capacitor network 500, while avoiding undesirably high switching currents when the charge pump power conversion circuit is not yet operating in steady-state, even in implementations where the characteristics of the power switches and/or fly capacitors are unknown to the control circuitry. Thus, the soft-start systems and methods of the present disclosure do not require prior knowledge of the characteristics of the MOSFET switches or the capacitances of the fly capacitors to be employed in the switched capacitor network 500. For example, the enhancement factors k_{HB} and k_{HA} of the high-side phase switches P_{HA} and P_{HB} for the initial cycle of operation (phases φ₁, φ₂) may be 0 and progressively increased over successive cycles of operation to 1 regardless of the characteristics of the MOSFET switches or the capacitances of the fly capacitors to be employed in the switched capacitor network 500.

### Step-Down Conversion Mode

Next, methods for powering up switched capacitor networks 100-130 to be operated in step-down conversion mode to transform a high-side input voltage V_{HI} into a low-side output voltage V_{LO} shall be described with reference to FIGS. 9A-9B. For simplicity, the methods will be described in detail with respect to switched capacitor network 100 of FIG. 1A, but it is to be understood that these methods apply equally to the switched capacitor networks 110-130 of FIGS. 1B-1D. The switched capacitor network 900 of FIG. 9A is identical to the switched capacitor network 100 of FIG. 1A except that the series switches S₂ through S_{2N} are initially partially enhanced, and their respective enhancement factors k_{S2} through k_{S(2N)} are ramped up over time before commencing switching (phases φ₁, φ₂) operation of the switched capacitor network, as explained in further detail below. In step-down conversion mode, to avoid undesirably high switching currents upon commencement of switching (phased operation), the voltages at the positive terminals of the fly capacitors can be brought up to close to their values in steady-state before commencement of switching (phased operation) of the switched capacitor network. This can be accomplished by turning ON series switches S₂ through S_{2N} in partially enhanced mode and ramping up their respective enhancement factors k_{S2} through k_{S(2N)} over time as shown in FIG. 9B.

In various embodiments, the remaining series switch S₁ may be turned ON and operated in a fully enhanced mode. In some embodiments, the remaining series switch S₁ may be turned ON in partially enhanced mode with its respective enhancement factor k_{S1} ramped up over time. Also, the low-side phase switches P_{LA} and P_{LB} may be turned ON and fully enhanced (e.g., operated at their respective maximum rated gate-to-source voltages) while the high-side phase switches P_{HA} and P_{HB} are turned OFF, to electrically connect the negative terminals n_{A} and n_{B} of the fly capacitors to the reference voltage. By ramping up the enhancement factors of series switches S₂ through S_{2N} in partially enhanced mode, the currents during this start-up phase may be controlled, avoiding excessive current levels that may over stress or damage one or more of the series switches. After the voltages of the fly capacitors with respect to the reference voltages have been brought up to close to their values in steady-state, phased (φ₁, φ₂) operation of the switched capacitor network may be commenced without inducing undesirably high switching currents. For example, each voltage at each positive terminal of each fly capacitor may be compared against a respective threshold value V_{Flyk_th} using a comparator circuit. In some embodiments, the threshold voltages V_{Flyk_th} associated with the fly capacitors may be proportionate with respect to each, e.g., V_{Flyk_th}=k*V_{Fly0_th}, where V_{Fly0_th} is a reference threshold voltage.

After each of the fly capacitor voltages reach or exceed their respective thresholds, operation of the switched capacitor network may be commenced without inducing undesirably high switching currents.

As shown in FIG. 9B, the enhancement factors k_{S2} through k_{S(2N)} of the series switches S₂ through S_{2N} may be ramped up at different rates. For example, the steady-state voltage at the positive terminal p_{(2N-1)} of fly capacitor C_{Fly(2N-1)} is expected to be higher than the steady-state voltage at the positive terminal p₁ of fly capacitor C_{Fly1}. Accordingly, in some embodiments, the enhancement factor k_{S(2N)} of series switch S_{2N} may be ramped up faster than the enhancement factor k₂ of series switch S₂. Further, in some embodiments, the enhancement factors of higher-numbered series switches may be ramped up faster than those of lower-numbered series switches. In some embodiments, the enhancement factors may be ramped up at different rates so that the fly capacitors complete their pre-charging to their respective expected steady-state values together at approximately the same time. In alternate embodiments, the enhancement factors of all series switches S₂ through S_{2N} may be ramped up at identical rates. In all the above embodiments, the remaining series switch S₁ may be turned ON and operated in a fully enhanced mode or ramped up based on an associated enhancement factor k_{S1.}

Referring to FIG. 9C, a process 950 for powering up a step-down charge pump power conversion circuit will be described in accordance with one or more embodiments. The process 950 may be implemented by controller circuit 920, which may also be configured to execute process 550 of FIG. 5D and/or one or more other processes described herein with reference to FIGS. 1-11.

The process 950 includes, in block 952, configuring a charge pump power conversion circuit to operate in a step-down conversion mode. In various embodiments, the charge pump power conversion circuit may be implemented as switched capacitor network 900 as described with reference to FIGS. 9A-B, as described with reference to FIGS. 1-8 and 10-11, or other charge pump implementation.

In various embodiments, the charge pump power conversion circuit includes interconnected switches and fly capacitors, with each switch operable to cycle between at least two switching configurations. The switches may include a series switch, with the series switch (e.g., a MOSFET) being one of a subset of the switches that are coupled in series between a step-down input node and a step-down output node of the charge pump power conversion circuit. One of the fly capacitors may have a fly capacitor terminal connected to the series switch, such as to a source terminal of a MOSFET series switch.

In block 954, the process 950 includes increasing over the period of time a gate-to-source voltage of the MOSFET series switch. In some embodiments, block 954 may further include controlling a driver circuit coupled to a gate terminal of the MOSFET series switch via a variable current source. In various embodiments, the rates of increase may the same for each series switch or each series switch may have its own corresponding rate of increase. Block 954 may further include increasing over the period of time gate-to-source voltages of the other series switches.

In block 956, the process 950 includes increasing over a period of time a voltage achieved at the fly capacitor terminal by applying an input voltage at the step-down input node and operating the series switch. In some embodiments, the series switch is a current source and increasing over the period of time the voltage achieved at the fly capacitor terminal includes increasing over the period of time a current sourced by the series switch.

In block 958, the process 950 includes determining whether the voltage achieved at the fly capacitor terminal meets or is within a hysteresis threshold voltage range. In block 960, the process 950 includes, after determining that the voltage achieved at the fly capacitor terminal exceeds the threshold voltage, operating the switches to cycle the network between the at least two switching configurations. In some embodiments, the process 950 may further include operating the other switches at their respective maximum rated gate-to-source voltages.

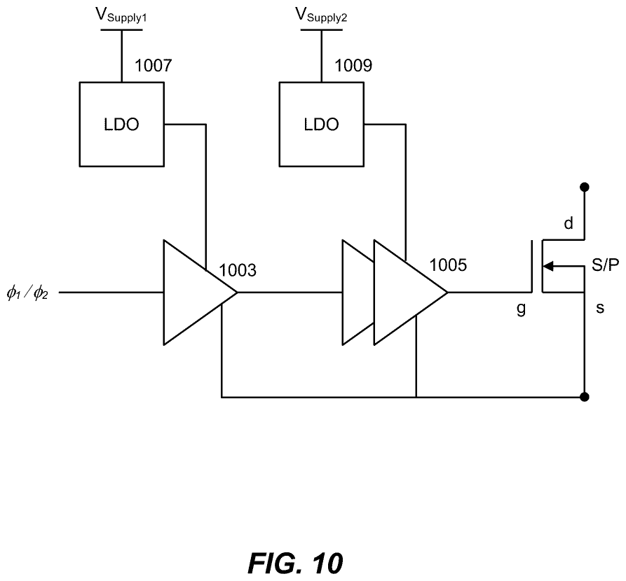

In various embodiments, the phase switches P_{LA}, P_{LB}, P_{HA}, and P_{HB}, and the series switches S₁, S₂, . . . S_{2N} are N-channel enhancement type metal-oxide-semiconductor field-effect transistors (MOSFETs), but it is to be understood that any other type of MOSFET, and indeed any other type of known switching device, may be used. During phased operation (φ₁, φ₂) of these switches, as shown in FIG. 10 (and as previously described with reference to the embodiments of FIGS. 1-9B), the gate terminal of each switch in the switched capacitor network may be driven with a clock signal representing the phase (φ₁, φ₂) of operation, and using a level shifter circuit 1003 and a gate driver circuit 1005. A clock signal generator, level shifter circuit 1003, gate driver circuit 1005 and other circuity and logic described herein with respect to FIGS. 1-10 may be implemented in control circuits 520, 920 as appropriate.

As shown in FIG. 10, in some embodiments, the level shifter circuit 1003 and gate driver circuit 1005 for a switching device, such as a series switch or phase switch, may be driven using separate linear regulators 1007 and 1009 respectively (e.g., low drop-out voltage regulators or other linear regulator circuitry as appropriate), which may be powered using a separate supply voltages V_{Supply1} and V_{Supply2} respectively. A reason for using separate linear regulators with separate supply voltages for the level shifter circuit 1003 and the gate driver circuit 1005 is that level shifter circuits may typically be sensitive to supply voltage fluctuations, which in this case may be caused by transients in the gate voltages if the level shifter circuit 1003 and the gate driver circuit 1005 share a linear regulator with a single supply voltage. In general, an external input voltage to the switched capacitor network, such as V_{INT} (from an external power supply) or V_{BAT} (from an external battery), may be chosen as the supply voltage for a linear regulator powering the sensitive level shifter circuit 1003, whereas a fluctuating intermediate voltage within the switched capacitor circuit, such as the voltages at the positive terminals p₁, p₂, . . . p_{2N} or p_{1_OP}, p_{2_OP}, . . . p_{2N_OP} may be employed as a supply voltage for the linear regulator powering the gate driver circuit 1005. During phased operation (φ₁, φ₂) of the switches, the positive terminals p₁, p₂, . . . p_{2N} or p_{1_OP}, p_{2_OP}, . . . p_{2N_OP} of the fly capacitors may be electrically connected to the source terminal(s) of the respective MOSFET switches. The drain terminal (d) of each MOSFET switch may be electrically connected to the source terminals(s) of other MOSEFT switches, or to the input or output terminals of the switched capacitor network.

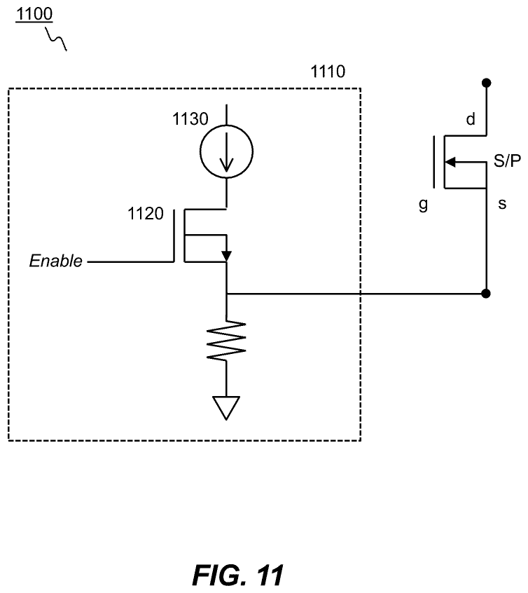

In such embodiments where the phase switches P_{LA}, P_{LB}, P_{HA}, and P_{HB}, and the series switches S₁, S₂, . . . S_{2N} are MOSFETs, control over the enhancement factors k_{HB} and k_{HA} of the high-side phase switches P_{HA} and P_{HB} in switched capacitor network 500, and the enhancement factors k_{S2} through k_{S(2N)} of the series switches S₂ through S_{2N} in switched capacitor network 900, may be accomplished by operating each MOSFET in its triode or linear regime such that as the gate-to-source voltage increases, the current flow from drain to source (“drain current”) also increases in approximately linear fashion, tending to increase the source voltage. The charge pump power conversion circuit may include separate driver circuits from the level shifter circuit 1003 and gate driver circuit 1005. For example, the level shifter circuit 1003 and gate driver circuit 1005 may be temporarily disconnected from the MOSFET switches while the fly capacitors are pre-charged to approximately their steady-state values as described above. As shown in FIG. 11, driver circuit 1110 is coupled to a gate terminal of the MOSFET series switch S/P, and the voltage output of the driver circuit V_{Drive} is configured to be the controlled via a variable current source. The driver circuit 1110 of FIG. 11 may include a variable current source 1130 supplying current to a p-MOSFET 1120 to generate a variable voltage output of the driver circuit that controls the S/P MOSFET switches of the switched capacitor network. Any other MOSFET switches in the switched capacitor network that are turned ON may be operating in fully enhanced mode (e.g., driven by the level shifter circuit 1003 and gate driver circuit 1005 of FIG. 10 at their respective maximum rated gate-to-source voltages).

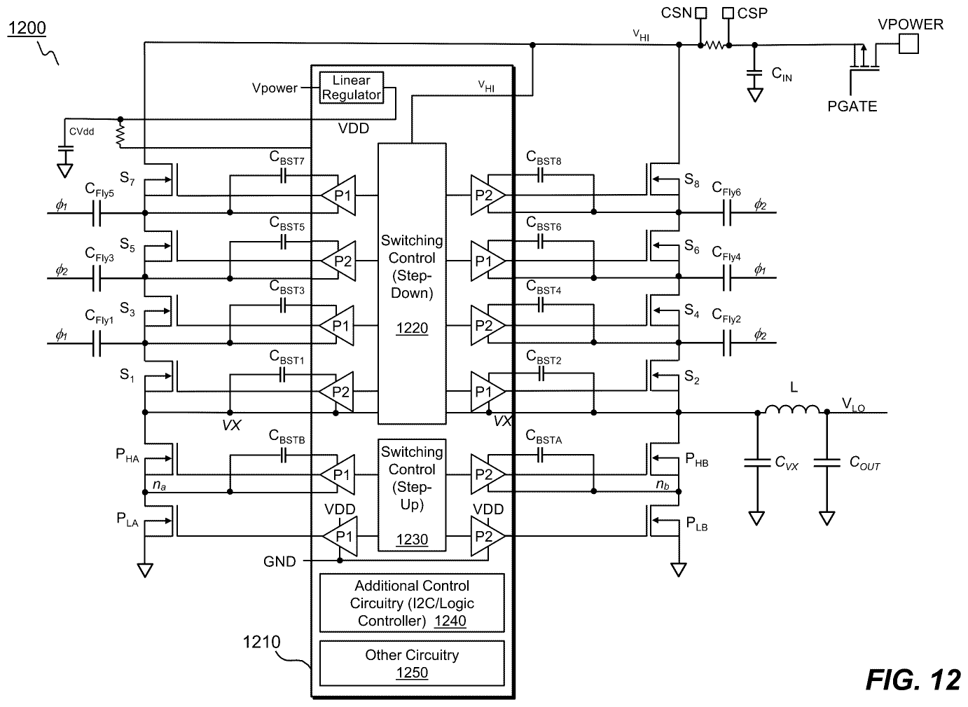

FIG. 12 illustrates example control circuitry, switching circuitry, and fly capacitors for an example step-up/step-down charge pump power conversion circuit, consistent with disclosed embodiments. As illustrated, a charge pump power conversion circuit 1200 includes control circuitry 1210 provided on a first integrated circuit, switching circuitry including a plurality of power switches S₁₋₈ and phase switches P_{HA}, P_{LA}, P_{HB}, and P_{LB}, and a plurality of fly capacitors C_{FLY1-6}, which may be implemented on one or more integrated circuits external to the first integrated circuit. In some embodiments, the control circuitry 1210, switching circuitry, and fly capacitors may be implemented in other circuit arrangements, including combining various elements into one or more integrated circuits.

The control circuitry 1210 may be configurable to operate the switching circuitry in one or more power conversion modes, such as a step-up power conversion mode and/or a step-down power conversion mode, and implement improved soft-start systems and methods as described herein with respect to FIGS. 1-11 to facilitate safe and efficient startup of the charge pump power conversion circuit 1200. The control circuitry 1210 may be configurable to operate with various charge pump power conversion circuit designs, including charge pump power conversion circuits having fly capacitors and/or switching circuitry with characteristics that are unknown to the control circuitry.

In the illustrated embodiment, for example, the charge pump power conversion circuit 1200 is configurable to operate as a divide by 4 charge pump. In other embodiments, the control circuitry 1210 may be configurable to operate as a 3× charge pump, a divide by 3 charge pump, a 2× charge pump, a divide by 2 charge pump, and/or other circuit configuration in accordance with system requirements. In various embodiments, the same control circuitry 1210 may be configured for use with various power switch and fly capacitor circuit configurations (e.g., as described herein with reference to FIGS. 1-11).

The charge pump power conversion circuit 1200 of the illustrated embodiment further includes a plurality of bootstrap capacitors C_{BST1-8} and C_{BSTA-B}, an inductor L coupled to a capacitor C_{OUT}, and other circuitry as appropriate for a particular implementation. The control circuit 1210 includes a linear regulator, a plurality of gate drivers P1 and P2, switching control circuity 1220 for implementing a step-down charge pump mode of operation, switching control circuitry 1230 configured to implement a step-up charge pump mode of operation, additional control circuitry 1240 (e.g., logic controller, I2C, MTP, or other controllers) and other circuitry 1250 (e.g., oscillator circuit, fault protection circuitry, reference/bias circuitry, and other circuitry as appropriate for a particular implementation). In various embodiments, the control circuitry 1210 is configurable for dual phase operation, including switching between a first phase φ₁ and a second phase φ₂ in accordance with a duty cycle as described herein with respect to FIGS. 1-11.

The disclosed embodiments may be further described by the following examples:
Example 1: A method for powering up a charge pump circuit, the charge pump circuit capable of operating as a step-up converter and comprising: a network of interconnected switches and fly capacitors, each switch operable between ON and OFF states to cycle the network between at least two switching configurations; wherein a first switch of the switches is connected to a fly capacitor terminal and a step-up input node of the charge pump circuit; the method comprising: increasing over a period of time a voltage achieved at the fly capacitor terminal during the ON state of the first switch by controlling the first switch, while operating the switches to transition the network between the at least two switching configurations.
Example 2: The method of example 1, wherein the first switch is a MOSFET, a drain terminal of the first switch MOSFET is connected to the step-up input node of the charge pump circuit, and a source terminal of the first switch MOSFET is connected to the fly capacitor terminal.
Example 3: The method of examples 1 or 2, further comprising: increasing over the period of time a gate-to-source voltage of the first switch MOSFET during its ON state, while operating the switches to transition the network between the at least two switching configurations.
Example 4: The method of any of examples 1-3, wherein the charge pump circuit further comprises: a driver circuit coupled to a gate terminal of the first switch MOSFET, wherein a voltage output of the driver circuit is configured to be the controlled via a variable current source.
Example 5: The method of any of examples 1-4, wherein the switches are all MOSFETs, the method further comprising: increasing over the period of time the gate-to-source voltage of the first switch MOSFET during its ON state to the gate-to-source voltage of the other MOSFET switches during their respective ON states.
Example 6: The method of any of examples 1-5, wherein the other MOSFET switches are operated at their respective maximum rated gate-to-source voltages during their respective ON states over the period of time.
Example 7: The method of any of examples 1-6, wherein the charge pump circuit further comprises: a plurality of gate driver circuits, each gate driver circuit coupled to a gate terminal of a corresponding other MOSFET switch.
Example 8: The method of any of examples 1-7, wherein the charge pump circuit further comprises: a plurality of bootstrapping circuits, each bootstrapping circuit configured to power a corresponding gate driver circuit.
Example 9: The method of any of examples 1-8, wherein the first switch is a current source, and wherein increasing over the period of time the voltage achieved at the fly capacitor terminal during the ON state of the first switch comprises: increasing over the period of time a current sourced by the first switch during its ON state.
Example 10: The method of any of examples 1 to 9, wherein the charge pump circuit is further capable of operating as a step-down converter after the period of time.
Example 11: A step-up power conversion apparatus, comprising, a charge pump circuit, including a network of interconnected switches and fly capacitors, each switch operable between ON and OFF states to cycle the network between at least two switching configurations; wherein a first switch of the switches is connected to a fly capacitor terminal and a step-up input node of the charge pump circuit; wherein the charge pump circuit is configured to increase over a period of time a voltage achieved at the fly capacitor terminal during the ON state of the first switch by controlling the first switch, while operating the switches to transition the network between the at least two switching configurations.
Example 12: The apparatus of example 11, wherein the first switch is a MOSFET, a drain terminal of the first switch MOSFET is connected to the step-up input node of the charge pump circuit, and a source terminal of the first switch MOSFET is connected to the fly capacitor terminal.
Example 13: The apparatus of any of examples 11-12, wherein the charge pump circuit is further configured to increase over the period of time a gate-to-source voltage of the first switch MOSFET during its ON state, while operating the switches to transition the network between the at least two switching configurations.
Example 14: The apparatus of any of examples 11-13, wherein the charge pump circuit further comprises: a driver circuit coupled to a gate terminal of the first switch MOSFET, wherein a voltage output of the driver circuit is configured to be the controlled via a variable current source.
Example 15: The apparatus of any of examples 11-14, wherein the switches are all MOSFETs and the charge pump circuit is further configured to increase over the period of time the gate-to-source voltage of the first switch MOSFET during its ON state to the gate-to-source voltage of the other MOSFET switches during their respective ON states.
Example 16: The apparatus of any of examples 11-15, wherein the other MOSFET switches are operated at their respective maximum rated gate-to-source voltages during their respective ON states over the period of time.
Example 17: The apparatus of any of examples 11-16, wherein the charge pump circuit further comprises: a plurality of gate driver circuits, each gate driver circuit coupled to a gate terminal of a corresponding other MOSFET switch.
Example 18: The apparatus of any of examples 11-17, wherein the charge pump circuit further comprises: a plurality of bootstrapping circuits, each bootstrapping circuit configured to power a corresponding gate driver circuit.
Example 19: The apparatus of any of examples 11-18, wherein the first switch is a current source, and wherein increasing over the period of time the voltage achieved at the fly capacitor terminal during the ON state of the first switch comprises: increasing over the period of time a current sourced by the first switch during its ON state.
Example 20: The apparatus of any of examples 11-19, wherein the charge pump circuit is further capable of operating as a step-down converter after the period of time.
Example 21: An integrated circuit, comprising, a charge pump controller circuit, the charge pump controller circuit couplable to a plurality of switches and a plurality of fly capacitors forming a network of interconnected switches and fly capacitors, wherein each switch is operable between ON and OFF states to cycle the network between at least two switching configurations; wherein a first switch of the switches is connectable to a fly capacitor terminal and a step-up input node of the charge pump circuit; wherein the charge pump controller circuit is configured to increase over a period of time a voltage achieved at the fly capacitor terminal during the ON state of the first switch by controlling the first switch, while operating the switches to transition the network between the at least two switching configurations.
Example 22: The integrated circuit of example 21, wherein the first switch is a MOSFET, a drain terminal of the first switch MOSFET is connected to the step-up input node of the charge pump circuit, and a source terminal of the first switch MOSFET is connected to the fly capacitor terminal.
Example 23: The integrated circuit of any of examples 21-22, wherein the charge pump controller circuit is further configured to increase over the period of time a gate-to-source voltage of the first switch MOSFET during its ON state, while operating the switches to transition the network between the at least two switching configurations.
Example 24: The integrated circuit of any of examples 21-23, wherein the charge pump controller circuit further comprises: a driver circuit coupled to a gate terminal of the first switch MOSFET, wherein a voltage output of the driver circuit is configured to be the controlled via a variable current source.
Example 25: The integrated circuit of any of examples 21-24, wherein the switches are all MOSFETs and the charge pump controller circuit is further configured to increase over the period of time the gate-to-source voltage of the first switch MOSFET during its ON state to the gate-to-source voltage of the other MOSFET switches during their respective ON states.
Example 26: The integrated circuit of any of examples 21-25, wherein the other MOSFET switches are operated at their respective maximum rated gate-to-source voltages during their respective ON states over the period of time.
Example 27: The integrated circuit of any of examples 21-26, wherein the charge pump controller circuit further comprises: a plurality of gate driver circuits, each gate driver circuit coupled to a gate terminal of a corresponding other MOSFET switch.
Example 28: The integrated circuit of any of examples 21-27, wherein the charge pump controller circuit further comprises: a plurality of bootstrapping circuits, each bootstrapping circuit configured to power a corresponding gate driver circuit.
Example 29: The integrated circuit of any of examples 21-28, wherein the first switch is a current source, and wherein increasing over the period of time the voltage achieved at the fly capacitor terminal during the ON state of the first switch comprises: increasing over the period of time a current sourced by the first switch during its ON state.
Example 30: The integrated circuit of any of examples 21-29, wherein the charge pump controller circuit is further capable of operating the network of interconnected switches and fly capacitors as a step-down converter after the period of time.
Example 31: A charge pump circuit configured to perform the method of any of examples 1-10.
Example 32: The charge pump circuit of example 31, wherein the charge pump circuit is an integrated circuit.
Example 33: The charge pump circuit of any of examples 31-32, wherein the charge pump circuit is an integrated circuit excluding the first switch.
Example 34: The charge pump circuit of any of examples 31-33, wherein the charge pump circuit is an integrated circuit excluding all the switches.
Example 35: The charge pump circuit of any of examples 31-34, wherein the charge pump circuit is an integrated circuit excluding the fly capacitors.
Example 36: The charge pump circuit of any of examples 31-35, wherein the charge pump circuit is an integrated circuit excluding the first switch and the fly capacitors.
Example 37: The charge pump circuit of any of examples 31-36, wherein the charge pump circuit is an integrated circuit excluding all the switches and the fly capacitors.
Example 38: A method for powering up a charge pump circuit, the charge pump circuit capable of operating as a step-down converter and comprising: a network of interconnected switches couplable to fly capacitors, the network configured to cycle between at least two switching configurations, wherein the switches include a series switch, the series switch being one of a subset of the switches that are coupled in series between a step-down input node and a step-down output node of the charge pump circuit, wherein one of the fly capacitors has a fly capacitor terminal connected to the series switch; the method comprising: increasing over a period of time a voltage achieved at the fly capacitor terminal by applying an input voltage at the step-down input node and operating the series switch; determining that the voltage achieved at the fly capacitor terminal exceeds a threshold voltage; and after determining that the voltage achieved at the fly capacitor terminal exceeds the threshold voltage, operating the switches to cycle the network between the at least two switching configurations.
Example 39: The method of example 38, wherein the series switch is a MOSFET, and the fly capacitor terminal is connected to a source terminal of the MOSFET series switch.
Example 40: The method of any of examples 38-39, wherein increasing over the period of time the voltage achieved at the fly capacitor terminal comprises: increasing over the period of time a gate-to-source voltage of the MOSFET series switch.
Example 41: The method of any of examples 38-40, wherein the charge pump circuit further comprises: a driver circuit coupled to a gate terminal of the MOSFET series switch, wherein a voltage output of the driver circuit is configured to be the controlled via a variable current source.
Example 42: The method of any of examples 38-41, wherein the series switch is a current source, and wherein increasing over the period of time the voltage achieved at the fly capacitor terminal comprises: increasing over the period of time a current sourced by the series switch.
Example 43: The method of any of examples 38-42, wherein each fly capacitor has a corresponding fly capacitor terminal connected to at least two of the subset of the switches that are coupled in series between the step-down input node and the step-down output node of the charge pump circuit, the method further comprising: increasing over the period of time voltages achieved at the fly capacitor terminals; determining that the voltages achieved at the fly capacitor terminals exceed corresponding threshold voltages; and after determining that the voltages achieved at the fly capacitor terminals exceed the corresponding threshold voltages, operating the switches to transition the network between the at least two switching configurations.
Example 44: The method of any of examples 38-43, further comprising: increasing over the period of time the voltages achieved at the fly capacitor terminals simultaneously.
Example 45: The method of any of examples 38-44, wherein rates of increase of the voltages achieved at the fly capacitor terminals over the period of time are different from each other.
Example 46: The method of any of examples 38-45, wherein at least one of the threshold voltages is about an integer multiple of another of the threshold voltages.
Example 47: The method of any of examples 38-46, wherein the switches are all MOSFETs, the method further comprising: increasing over the period of time gate-to-source voltages of the series switches to gate-to-source voltage of the other switches.
Example 48: The method of any of examples 38-47, wherein the other switches are operated at their respective maximum rated gate-to-source voltages.
Example 49: A step-up power conversion apparatus, comprising, a charge pump circuit, including a network of interconnected switches couplable to fly capacitors, the network configured to cycle between at least two switching configurations, wherein the switches include a series switch, the series switch being one of a subset of the switches that are coupled in series between a step-down input node and a step-down output node of the charge pump circuit, wherein one of the fly capacitors has a fly capacitor terminal connected to the series switch; wherein the charge pump circuit is configured to: increase over a period of time a voltage achieved at the fly capacitor terminal by applying an input voltage at the step-down input node and operating the series switch; determine that the voltage achieved at the fly capacitor terminal exceeds a threshold voltage; and after determining that the voltage achieved at the fly capacitor terminal exceeds the threshold voltage, operating the switches to cycle the network between the at least two switching configurations.
Example 50: The apparatus of example 49, wherein the series switch is a MOSFET, and the fly capacitor terminal is connected to a source terminal of the MOSFET series switch.
Example 51: The apparatus of any of examples 49-50, wherein increasing over the period of time the voltage achieved at the fly capacitor terminal comprises: increasing over the period of time a gate-to-source voltage of the MOSFET series switch.
Example 52: The apparatus of any of examples 49-51, wherein the charge pump circuit further comprises: a driver circuit coupled to a gate terminal of the MOSFET series switch, wherein a voltage output of the driver circuit is configured to be the controlled via a variable current source.
Example 53: The apparatus of any of examples 49-52, wherein the series switch is a current source, and wherein increasing over the period of time the voltage achieved at the fly capacitor terminal comprises: increasing over the period of time a current sourced by the series switch.
Example 54: The apparatus of any of examples 49-53, wherein each fly capacitor has a corresponding fly capacitor terminal connected to at least two of the subset of the switches that are coupled in series between the step-down input node and the step-down output node of the charge pump circuit, the charge pump circuit further configured to: increase over the period of time voltages achieved at the fly capacitor terminals; determine that the voltages achieved at the fly capacitor terminals exceed corresponding threshold voltages; and after determining that the voltages achieved at the fly capacitor terminals exceed the corresponding threshold voltages, operate the switches to transition the network between the at least two switching configurations.
Example 55: The apparatus of any of examples 49-54, the charge pump circuit further configured to: increase over the period of time the voltages achieved at the fly capacitor terminals simultaneously.
Example 56: The apparatus of any of examples 49-55, wherein rates of increase of the voltages achieved at the fly capacitor terminals over the period of time are different from each other.
Example 57: The apparatus of any of examples 49-56, wherein at least one of the threshold voltages is about an integer multiple of another of the threshold voltages.
Example 58: The apparatus of any of examples 49-57, wherein the switches are all MOSFETs, the charge pump circuit further configured to: increase over the period of time gate-to-source voltages of the series switches to gate-to-source voltage of the other switches.
Example 59: The apparatus of any of examples 49-58, wherein the other switches are operated at their respective maximum rated gate-to-source voltages.
Example 60: An integrated circuit, comprising, a charge pump controller circuit, the charge pump controller circuit couplable to a plurality of switches and a plurality of fly capacitors forming a network of interconnected switches and fly capacitors, wherein each switch is operable between ON and OFF states to cycle the network between at least two switching configurations; wherein the switches include a series switch, the series switch being one of a subset of the switches that are coupled in series between a step-down input node and a step-down output node of the charge pump circuit, wherein one of the fly capacitors has a fly capacitor terminal connected to the series switch; wherein the charge pump circuit is configured to: increase over a period of time a voltage achieved at the fly capacitor terminal by applying an input voltage at the step-down input node and operating the series switch; determine that the voltage achieved at the fly capacitor terminal exceeds a threshold voltage; and after determining that the voltage achieved at the fly capacitor terminal exceeds the threshold voltage, operating the switches to cycle the network between the at least two switching configurations.
Example 61: The integrated circuit of example 60, wherein the series switch is a MOSFET, and the fly capacitor terminal is connected to a source terminal of the MOSFET series switch.
Example 62: The integrated circuit of any of examples 60-61, wherein increasing over the period of time the voltage achieved at the fly capacitor terminal comprises: increasing over the period of time a gate-to-source voltage of the MOSFET series switch.
Example 63: The integrated circuit of any of examples 60-62, wherein the charge pump circuit further comprises: a driver circuit coupled to a gate terminal of the MOSFET series switch, wherein a voltage output of the driver circuit is configured to be the controlled via a variable current source.
Example 64: The integrated circuit of any of examples 60-63, wherein the series switch is a current source, and wherein increasing over the period of time the voltage achieved at the fly capacitor terminal comprises: increasing over the period of time a current sourced by the series switch.
Example 65: The integrated circuit of any of examples 60-64, wherein each fly capacitor has a corresponding fly capacitor terminal connected to at least two of the subset of the switches that are coupled in series between the step-down input node and the step-down output node of the charge pump circuit, the charge pump circuit further configured to: increase over the period of time voltages achieved at the fly capacitor terminals; determine that the voltages achieved at the fly capacitor terminals exceed corresponding threshold voltages; and after determining that the voltages achieved at the fly capacitor terminals exceed the corresponding threshold voltages, operate the switches to transition the network between the at least two switching configurations.
Example 66: The integrated circuit of any of examples 60-65, the charge pump circuit further configured to: increase over the period of time the voltages achieved at the fly capacitor terminals simultaneously.
Example 67: The integrated circuit of any of examples 60-66, wherein rates of increase of the voltages achieved at the fly capacitor terminals over the period of time are different from each other.
Example 68: The integrated circuit of any of examples 60-67, wherein at least one of the threshold voltages is about an integer multiple of another of the threshold voltages.
Example 69: The integrated circuit of any of examples 60-68, wherein the switches are all MOSFETs, the charge pump circuit further configured to: increase over the period of time gate-to-source voltages of the series switches to gate-to-source voltage of the other switches.
Example 70: The integrated circuit of any of examples 60-69, wherein the other switches are operated at their respective maximum rated gate-to-source voltages.
Example 71: A charge pump circuit configured to perform the method of any of examples 38-48.
Example 72: The charge pump circuit of example 71, wherein the charge pump circuit is an integrated circuit.
Example 73: The charge pump circuit of any of examples 71-72, wherein the charge pump circuit is an integrated circuit excluding the series switch.
Example 74: The charge pump circuit of any of examples 71-73, wherein the charge pump circuit is an integrated circuit excluding all the switches.
Example 75: The charge pump circuit of any of examples 71-74, wherein the charge pump circuit is an integrated circuit excluding the fly capacitors.
Example 76: The charge pump circuit of any of examples 71-75, wherein the charge pump circuit is an integrated circuit excluding the series switch and the fly capacitors.
Example 77: The charge pump circuit of any of examples 71-76, wherein the charge pump circuit is an integrated circuit excluding all the switches and the fly capacitors.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is also intended that the sequence of steps shown in figures are only for illustrative purposes and are not intended to be limited to any particular sequence of steps. As such, those skilled in the art can appreciate that these steps can be performed in a different order while implementing the same method.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiments of the specification. Certain features described in the context of various embodiments are not to be considered essential features of those embodiments unless the embodiment is inoperative without those elements.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this disclosure, the term “coupled” may also be termed as “electrically coupled”, and the term “connected” may be termed as “electrically connected”. “Coupled” and “connected” may also be used to indicate that two or more elements cooperate or interact with each other.

While embodiments of the present disclosure may address some challenges and provide some benefits, the stated problems and features herein are intended to be examples and not limit the claims or scope of this disclosure. Indeed, the disclosed embodiments may address challenges and provide benefits not explicitly enumerated.

What is claimed is:

1. A method comprising:
configuring a charge pump circuit to operate in a step-down power conversion mode, the charge pump circuit comprising a network of interconnected switches and fly capacitors, the charge pump circuit operable to control each switch of the interconnected switches to cycle the network between at least two switching configurations, wherein the switches include a subset of the switches that are coupled in series between a step-down input node and a step-down output node of the charge pump circuit, and wherein one of the fly capacitors has a fly capacitor terminal connected to a series switch of the subset of switches;
increasing over a period of time a voltage achieved at the fly capacitor terminal by applying an input voltage at the step-down input node and operating the series switch;
determining that the voltage achieved at the fly capacitor terminal exceeds a threshold voltage; and
after determining that the voltage achieved at the fly capacitor terminal exceeds the threshold voltage, operating the switches to cycle the network between the at least two switching configurations.

2. The method of claim 1, wherein the series switch comprises a MOSFET series switch, and the fly capacitor terminal is connected to a source terminal of the MOSFET series switch.

3. The method of claim 2, wherein increasing over the period of time the voltage achieved at the fly capacitor terminal comprises:
increasing over the period of time a gate-to-source voltage of the MOSFET series switch.

4. The method of claim 3, wherein increasing over the period of the time voltage achieved at the fly capacitor terminal further comprises:
controlling a driver circuit coupled to a gate terminal of the MOSFET series switch via a variable current source.

5. The method of claim 1, wherein the series switch is a current source, and wherein increasing over the period of time the voltage achieved at the fly capacitor terminal comprises:
increasing over the period of time a current sourced by the series switch.

6. The method of claim 1, wherein each fly capacitor has a corresponding fly capacitor terminal connected to at least two of the subset of the switches that are coupled in series between the step-down input node and the step-down output node of the charge pump circuit,
the method further comprising:
increasing over the period of time voltages achieved at the fly capacitor terminals;
determining that the voltages achieved at the fly capacitor terminals exceed corresponding threshold voltages; and
after determining that the voltages achieved at the fly capacitor terminals exceed the corresponding threshold voltages, operating the switches to transition the network between the at least two switching configurations.

7. The method of claim 6, further comprising:
increasing over the period of time the voltages achieved at the fly capacitor terminals simultaneously.

8. The method of claim 7, wherein rates of increase of the voltages achieved at the fly capacitor terminals over the period of time are different from each other.

9. The method of claim 6, wherein at least one of the threshold voltages is an integer multiple of another of the threshold voltages.

10. The method of claim 6, wherein the switches comprise MOSFETs, the method further comprising:
increasing over the period of time gate-to-source voltages of the series switches to gate-to-source voltage of the other switches.

11. The method of claim 9, further comprising operating the other switches at their respective maximum rated gate-to-source voltages.

12. The method of claim 1, further comprising:
during the period of time, providing analog signals to control the series switch; and
after the period of time, providing digital signals to control the series switch.

13. The method of claim 1, further comprising, configuring the charge pump circuit to operate in a step-up power conversion mode; and
operating the switches to cycle the network between at least two step-up switching configurations.

14. An apparatus, comprising,
a charge pump circuit comprising a network of interconnected switches coupled to a plurality of fly capacitors, wherein the switches include a subset of the switches that are coupled in series between a step-down input node and a step-down output node of the charge pump circuit, and wherein one of the fly capacitors has a fly capacitor terminal connected to a series switch of the subset of switches; and
a charge pump controller circuit configured to cycle the network between at least two switching configurations, and wherein the charge pump controller circuit is further configured to:
increase over a period of time a voltage achieved at the fly capacitor terminal by applying an input voltage at the step-down input node and operating the series switch;
determine that the voltage achieved at the fly capacitor terminal exceeds a threshold voltage; and
after determining that the voltage achieved at the fly capacitor terminal exceeds the threshold voltage, operate the switches to cycle the network between the at least two switching configurations.

15. The apparatus of claim 14, wherein the series switch is a MOSFET series switch, and the fly capacitor terminal is connected to a source terminal of the MOSFET series switch.

16. The apparatus of claim 15, wherein increase over the period of time the voltage achieved at the fly capacitor terminal comprises:
increasing over the period of time a gate-to-source voltage of the MOSFET series switch.

17. The apparatus of claim 16, wherein the charge pump controller circuit further comprises:
a driver circuit coupled to a gate terminal of the MOSFET series switch, wherein a voltage output of the driver circuit is configured to be the controlled via a variable current source.

18. The apparatus of claim 14, wherein the series switch is a current source, and wherein increase over the period of time the voltage achieved at the fly capacitor terminal comprises:
increasing over the period of time a current sourced by the series switch.

19. The apparatus of claim 14, wherein each fly capacitor has a corresponding fly capacitor terminal connected to at least two of the subset of the switches that are coupled in series between the step-down input node and the step-down output node of the charge pump circuit; and
wherein the charge pump controller circuit is further configured to:
increase over the period of time voltages achieved at the fly capacitor terminals;
determine that the voltages achieved at the fly capacitor terminals exceed corresponding threshold voltages; and
after determining that the voltages achieved at the fly capacitor terminals exceed the corresponding threshold voltages, operate the switches to transition the network between the at least two switching configurations.

20. The apparatus of claim 19, the charge pump controller circuit is further configured to:
increase over the period of time the voltages achieved at the fly capacitor terminals simultaneously.

21. The apparatus of claim 20, wherein rates of increase of the voltages achieved at the fly capacitor terminals over the period of time are different from each other.

22. The apparatus of claim 21, wherein at least one of the threshold voltages is an integer multiple of another of the threshold voltages.

23. The apparatus of claim 22, wherein the switches comprise MOSFETs; and
wherein the charge pump controller circuit is further configured to:
increase over the period of time gate-to-source voltages of the series switches to gate-to-source voltage of the other switches.

24. The apparatus of claim 23, wherein the charge pump controller circuit is further configured to operate the other switches at their respective maximum rated gate-to-source voltages.

25. The apparatus of claim 14, wherein the charge pump controller circuit is further configured to, during the period of time, provide analog signals to control the series switch, and after the period of time, provide digital signals to control the series switch.

26. The apparatus of claim 14, wherein the charge pump controller circuit is further configured to operate the charge pump circuit in a step-up power conversion mode by operating the switches to cycle the network between at least two step-up switching configurations.

27. An integrated circuit, comprising:
a charge pump controller circuit couplable to a plurality of switches and a plurality of fly capacitors forming a network of interconnected switches and fly capacitors, wherein the charge pump controller circuit is operable to control each of the plurality of switches to cycle the network between at least two switching configurations;
wherein the switches include a series switch, the series switch being one of a subset of the switches that are coupled in series between a step-down input node and a step-down output node of the network, and wherein one of the fly capacitors has a fly capacitor terminal connected to the series switch; and
wherein the charge pump controller circuit is further configured to:
increase over a period of time a voltage achieved at the fly capacitor terminal by applying an input voltage at the step-down input node and operating the series switch;
determine that the voltage achieved at the fly capacitor terminal exceeds a threshold voltage; and
after determining that the voltage achieved at the fly capacitor terminal exceeds the threshold voltage, operate the switches to cycle the network between the at least two switching configurations.

28. The integrated circuit of claim 27, wherein the series switch is a MOSFET series switch, and the fly capacitor terminal is connected to a source terminal of the MOSFET series switch.

29. The integrated circuit of claim 28, wherein increase over the period of time the voltage achieved at the fly capacitor terminal comprises:
increasing over the period of time a gate-to-source voltage of the MOSFET series switch.

30. The integrated circuit of claim 29, wherein the charge pump controller circuit further comprises:
a driver circuit coupled to a gate terminal of the MOSFET series switch, wherein a voltage output of the driver circuit is configured to be the controlled via a variable current source.

31. The integrated circuit of claim 30, wherein the series switch is a current source, and wherein increase over the period of time the voltage achieved at the fly capacitor terminal comprises:
increasing over the period of time a current sourced by the series switch.

32. The integrated circuit of claim 27, wherein each fly capacitor has a corresponding fly capacitor terminal connected to at least two of the subset of the switches that are coupled in series between the step-down input node and the step-down output node of the network; and
wherein the charge pump controller circuit further configured to:
increase over the period of time voltages achieved at the fly capacitor terminals;
determine that the voltages achieved at the fly capacitor terminals exceed corresponding threshold voltages; and
after determining that the voltages achieved at the fly capacitor terminals exceed the corresponding threshold voltages, operate the switches to transition the network between the at least two switching configurations.

33. The integrated circuit of claim 32, wherein the charge pump controller circuit is further configured to:
increase over the period of time the voltages achieved at the fly capacitor terminals simultaneously.

34. The integrated circuit of claim 33, wherein rates of increase of the voltages achieved at the fly capacitor terminals over the period of time are different from each other.

35. The integrated circuit of claim 34, wherein at least one of the threshold voltages is about an integer multiple of another of the threshold voltages.

36. The integrated circuit of claim 35, wherein the switches comprise MOSFETs; and
wherein the charge pump controller circuit is further configured to:
increase over the period of time gate-to-source voltages of the series switches to gate-to-source voltage of the other switches.

37. The integrated circuit of claim 36, wherein the other switches are operated at their respective maximum rated gate-to-source voltages.

38. The integrated circuit of claim 27, wherein, during the period of time, the charge pump controller circuit is configured to provide analog signals to control the series switch; and
wherein, after the period of time, the charge pump controller circuit is configured to provide digital signals to control the series switch.

39. The integrated circuit of claim 27, wherein the charge pump controller circuit is further configurable to operate the charge pump circuit in a step-up power conversion mode.
